(19) United States
(12) Patent Application Publication
(10) Pub. No.: US 2026/0084338 A1
(43) Pub. Date: Mar. 26, 2026

(54) Automated Plywood Production

(71) Applicant: RIOS Intelligent Machines, Inc., Menlo Park, CA (US)

(72) Inventors: Christopher A. Paulson, Belmont, CA (US); Laura Sullivan, Redwood City, CA (US); Leo Keselman, Santa Clara, CA (US); Michael Benedict, Palo Alto, CA (US); Scott M. Dellenbaugh, Fremont, CA (US); Josh A. Jimenez, San Francisco, CA (US); Paul A. Somero, Pacifica, CA (US)

(73) Assignee: RIOS Intelligent Machines, Inc., Menlo Park, CA (US)

(21) Appl. No.: 19/337,315

(22) Filed: Sep. 23, 2025

Related U.S. Application Data
(60) Provisional application No. 63/698,502, filed on Sep. 24, 2024.

(51) Int. Cl. B27D 1/04; B27D 1/10

(52) U.S. Cl. CPC B27D 1/04; B27D 1/10

(57) ABSTRACT

A plywood production work cell utilizes image sensor data to control robot mechanism(s) during an automated veneer stacking operation such that one side edge of each veneer layer is precisely vertically aligned with a corresponding side edge of a lowermost veneer. Each resulting stacked veneer assembly has an aligned side edge that requires minimal post-assembly processing and an opposing non-aligned (jagged, rough) side edge that is abraded/smoothed to produce a plywood panel having a specified width dimension. Selected end edges of at least some veneers are also precisely aligned during the stacking operation and opposing non-aligned end edges are abraded/smoothed to produce plywood panels having a specified length dimension. Each robot mechanism utilizes an end-tool having vacuum grippers arranged in a pair of X-shaped patterns below a horizontally oriented frame, where the image data is generated by cameras mounted on the frame.

### PRIORITY APPLICATION

The present application claims priority to U.S. Provisional Patent Application 63/698,502 entitled “AUTOMATED PLYWOOD PRODUCTION”, filed by Paulson et al. on Sep. 24, 2024.

### FIELD OF THE INVENTION

This invention relates to automated production systems, and more particularly to robotic work cells, end-tools and methods that are directed to the production of plywood panels.

### BACKGROUND OF THE INVENTION

Plywood is a composite panel material formed by bonding together a stack of thin layers of wood veneer (“plies”) in an alternating pattern (e.g., with the grain directions of adjacent layers offset by 90°). As used herein, the term “grain” refers to a tree's straight wood grain aspects formed by wood fibers aligned parallel to the tree's longitudinal axis. Alternating the grain direction (cross-graining) of adjacent layers provides plywood sheets (panels) with several important benefits over boards that have been carved/hewn from solid wood: cross-graining reduces the tendency of wood to split when nailed near the board's edge; cross-graining reduces expansion and shrinkage, providing plywood with improved dimensional stability over solid wood; and cross-graining makes the strength of plywood panels consistent across all directions. Plywood panels have various thicknesses determined by the number of layers/veneers forming each panel and usually include an odd number of layers/veneers with the grain directions of the two outermost veneers (i.e., the veneers that form the opposing upper and lower panel surfaces) being parallel, which provides enhanced stiffness perpendicular to the grain direction of the outermost layers/veneers. Thinner and lower quality plywood panels may only have layers/veneers with grain directions arranged at right angles to each other, but some better-quality plywood products include layers/veneers with grain directions that change in steps of 45 degrees (i.e., 0, 45, 90, 135, and 180 degrees), giving strength in multiple axes.

FIGS. 17 to 19 illustrate a simplified exemplary conventional plywood manufacturing process. Referring to FIG. 17, the plywood manufacturing process begins by generating the wood veneers (layers), which generally involves rotating a suitable log 50 (aka, peeler) about its long axis A while a long blade 60 is pressed against the log's cylindrical outer surface, thereby causing a thin wood layer 52 to peel off (e.g., like a peeling a sheet of paper from a roll). An adjustable nosebar (not shown), which may be solid or a roller, is pressed against log 50 during rotation to create a gap for wood layer 52 to pass between knife 60 and the nosebar, thereby controlling vibrations and generating wood layer 52 with an accurate thickness (i.e., as measured in the Z-axis direction). One or more cutting tools (not shown) then cut wood layer 52 along orthogonal lines (e.g., as indicated by perpendicular cut lines C1 and C2) into square sheets (half-size veneers) 54 and rectangular sheets (full-size veneers) 55. Note that the grain direction of each veneer 54 and 55, which is typically parallel to axis A of log 50, extends in the X-axis direction in FIG. 17. To allow for shrinkage when dried, the initial outside dimensions of both half-size veneers 54 and full-size veneers 55 are a suitable amount greater than the targeted final dimensions. For example, to generate plywood panels with standard 8′ by 4′ dimensions, each half-size veneer 54 is cut with an initial width W0 and an initial length L10 that are a suitable amount greater than 4′, and each full-size veneer 55 is cut with an initial width W0 that is greater than 4′ and an initial length L20 that is greater than 8′.

FIG. 18A depicts an exemplary conventional assembly process that may be used to form a three-ply plywood panel using two half-size veneers 54-1 and 54-2, a lowermost (first outer) full-size veneer 55-1 and an uppermost (second outer) full-size veneer 55-2. Note that the assembly process is performed after a suitable drying period, whereby the outer dimensions of each veneer sheet are smaller than the initial (fresh cut) dimensions described above with reference to FIG. 17, but still slightly greater than the targeted standard plywood panel dimension. That is, at the time of assembly, half-size veneers 54-1 and 54-2 have width/length dimensions W11 and L11 that are smaller than initial dimensions W0 and L10 (discussed above with reference to FIG. 17) but are still slightly more than the 4′ targeted final width/length. Similarly, full-size veneers 55-1 and 55-2 have width/length dimensions W21 and L21 that are smaller than initial dimensions W0 and L20 (discussed above with reference to FIG. 17) but are each still slightly more than 4′ and 8′, respectively. The conventional assembly process is typically performed by a skilled operator and begins by manually moving a lower (first) full-size veneer 55-1 from a supply stack onto a work surface. A first glue (adhesive) layer 70-1 is then sprayed or otherwise disposed on the upward-facing surface of lower full-size veneer 55-1. The operator then manually places (i.e., mounts or stacks) half-size veneers 54-1 and 54-2 onto lower full-size veneer 55-1 with first glue layer 70-1 sandwiched therebetween. Note that the respective grain directions half-size veneers 54-1 and 54-2 are oriented perpendicular to lower full-size veneer 55-1 (i.e., such that the grain directions of both half-size veneers 54-1 and 54-2 are generally parallel to the indicated X-axis, and the grain direction of lower full-size veneer 55-1 is generally parallel to the indicated Y-axis). Half-size veneers 54-1 and 54-2 are also positioned such that their outward facing end edges and side edges are generally aligned with corresponding peripheral edges of lower full-size veneer 55-1 (e.g., such that end edge 54-2E of half-size veneer 54-2 is generally aligned with end edge 55-1E of lower full-size veneer 55-1, and such that side edge 54-2S1 of half-size veneer 54-2 is generally aligned with side edge 55-1S1 of lower full-size veneer 55-1). A second glue layer 70-2 is then disposed on the upward-facing surfaces of (intermediate) half-size veneers 54-1 and 54-2, and then upper (second) full-size veneer 55-1 is placed onto half-size veneers 54-1 and 54-2 over second glue layer 70-2 such that the grain direction of upper full-size veneer 55-2 is parallel to the grain direction of lower full-size veneer 55-1, and such that the peripheral edges of lower full-size veneer 55-1 are aligned with corresponding edges of intermediate half-size veneers 55-1 and 55-2. The assembly process depicted in FIG. 18A produces an assembly 80 (e.g., as shown in FIG. 18B), where an outward-facing surface of lowermost full-size veneer 55-1 forms a first (e.g., lower) surface 81L of assembly 80, the outward-facing surface of uppermost full-size veneer 55-2 forms an opposing second (e.g., upper) surface 81U of assembly 80, and intermediate half-size veneers 55-1 and 55-2 form a core of assembly 80. At the end of the assembly process depicted in FIG. 18A, each assembly 80 may resemble a plywood panel, but must undergo post-assembly operations (e.g., the glue curing operation described below with reference to FIG. 18B and the peripheral edge smoothing/processing operation described below with reference to FIG. 19) in order to produce a completed plywood panel that is ready for commercial sale or use.

FIG. 18B depicts an exemplary glue curing (hot press) process typically performed after the assembly process described with reference to FIG. 18A and before the smoothing/processing operation described below with reference to FIG. 19. The exemplary glue curing process involves disposing assembly 80 between opposing plates 90-1 and 90-2 that are heated to a suitable temperature, and then causing a pressing mechanism (not shown) to push heated plates 90-1 and 90-2 toward each other (i.e., such that heated plate 90-1 presses upward on lower surface 81L of assembly 80, and such that heated plate 90-2 presses downward on upper surface 81U of assembly 80). Heated plates 90-1 and 90-2 are controlled to maintain assembly 80 at a suitable pressure P (e.g., 200 psi or higher) and a suitable temperature T (e.g., 280° F. or higher) for a suitable hot press period during which the intervening glue layers (i.e., glue layers 170-1 and 170-2, shown in FIG. 18A) are cured, thereby bonding the veneer sheets together. As indicated in FIG. 18B, after assembly and curing, assembly 80 has a width dimension W3 and a length dimension L3 that are somewhat larger than width/length dimensions W21 and L21 of full-size veneers 55-1 and 55-2 (shown in FIG. 18A) to account for veneer edge misalignments (i.e., as described below with reference to FIGS. 20A and 20B).

FIG. 19 depicts assembly 80 during an exemplary peripheral edge smoothing/processing operation. The peripheral edge smoothing/processing operation involves sanding, routing or otherwise abrading material from the four peripheral edge surfaces of each veneer assembly to provide finished plywood panels having smooth and flat peripheral side edges. This smoothing/processing operation is needed to correct/remove veneer edge misalignments, such as those depicted in FIGS. 20A and 20B, which are caused by: a) minor random variations in the length and width dimensions of the veneer sheets used to form the plywood panels (e.g., due to slight variations in the amount of shrinkage that occurs during the drying portion of the veneer sheet production process, described above), and b) minor veneer sheet alignment errors that typically arise during the assembly (veneer stacking) stage of the manufacturing process. FIG. 20A is a partial cross-section taken along section line 20A-20A (shown in FIG. 19) that depicts a selected section of side edge 83-1 of assembly 80 at a time T1 (i.e., depicting side edge 83-1 after assembly/curing but before being subjected to the smoothing/processing operation). Note that assembly side edge 83-1 extends from lower surface 81L to upper surface 81U, and that the various vertical veneer side edges that collectively form assembly side edge 83-1 (i.e., side edge 55-1S1 of lower full-size veneer 55-1, side edge 54-2S1 of intermediate square veneer 54-2 and side edge 54-2S1 of the upper full-size veneer 55-2) are offset in the horizontal (e.g., X-axis) direction (i.e., side edge 55-1S1 is offset from side edge 54-2S1 by a distance X1, and side edge 55-2S1 is offset from side edge 54-2S1 by a distance X2). FIG. 20B is a partial cross-section taken along section line 20B-20B (shown in FIG. 19) and depicts a similar edge misalignment issue generated by offsets between side edge 55-1S2 of lower rectangular veneer 55-1, side edge 54-2S2 of intermediate square veneer 54-2 and side edge 54-2S2 of the upper rectangular veneer 55-2, which collectively form side edge 83-2 of assembly 80 at time T1. FIGS. 21A and 21B respectively show corresponding cross sections taken along section lines 21A-21A and 21B-21B (shown in FIG. 19) and respectively depict corresponding sections of assembly side edges 83-1 and 83-2 at a time T2 (i.e., after assembly 80 is subjected to the smoothing/processing operation). As indicated by the dashed lines in FIG. 21A, the smoothing/processing operation removes portions of the stacked veneers such that assembly side edge 83-1(T2) extends in a vertical (Y-Z) plane between lower surface 81L and upper surface 81U (i.e., material is removed from side edge 55-1S1 of lower rectangular veneer 55-1, side edge 54-2S1 of intermediate square veneer 54-2 and side edge 54-2S1 of upper rectangular veneer 55-2 until these side edges are aligned). Similarly, as indicated by the dashed lines in FIG. 21B, material is removed from side edge 55-1S2 of lower rectangular veneer 55-1, side edge 54-2S2 of intermediate square veneer 54-2 and side edge 54-2S2 of upper rectangular veneer 55-2 until assembly side edge 83-2(T2) extends in a vertical (Y-Z) plane between lower surface 81L and upper surface 81U. A similar smoothing/processing operation may be performed to remove edge misalignments from end surfaces 82-1 and 82-2 of assembly 80 (shown in FIG. 19). In this way, the peripheral edge smoothing/processing operation, such as the exemplary operation depicted in FIG. 19, is utilized to correct/remove the undesirably rough (non-planar) peripheral panel edge surfaces (e.g., as depicted in FIGS. 20A and 20B), thereby providing finished plywood panels with smooth/planar peripheral edge surfaces 83-1(T2) and 83-2(T2), as depicted in FIGS. 21A and 21B, respectively.

A second objective of the smoothing/processing operation is to provide the finished plywood panels with the targeted standard length/width dimensions (e.g., 8′ by 4′). This second objective is achieved in the exemplary smoothing/processing operation depicted in FIG. 19, for example, by separating grinding tools 95-1 and 95-2 by an X-axis distance corresponding to the target width W (e.g., 4') and passing assembly 80 in the Y-axis direction (as indicated by arrow A) between grinding tools 95-1 and 95-2. With this arrangement, grinding tools 95-1 and 95-2 remove portions of assembly 80 disposed along each side edge 83-1 and 83-2 (i.e., the narrow section extending from dashed line 86-1 to panel side edge 83-1(T1) and the narrow section extending from dashed line 86-2 to panel side edge 83-2(T1)). As a result, the post-assembly/curing width W3 of assembly 80 at time T1 (i.e., the distance separating side edges 83-1(T1) and 83-2(T1) before smoothing/processing) is reduced to target width W at time T2 (i.e., the distance separating side edges 83-1(T2) and 83-2(T2) after the smoothing/processing operation). Note that a similar smoothing/processing operation may be performed on panel end surfaces 82-1 and 82-2 to reduce the length of assembly 80 from the post-assembly/curing length L3 (shown in FIG. 18B) to the target length L (e.g., 8′). In other embodiments (not shown), the smoothing/processing operation may be performed using methods other than those shown in FIG. 19, such as using a single grinding tool to sequentially smooth/process the four peripheral panel edges.

A problem with conventional plywood manufacturing processes is that they require veneers having length/width dimensions that are significantly greater than the targeted length/width dimensions of the finished plywood panels (e.g., 4′ by 8′) to accommodate random veneer edge misalignments. By way of example, it is assumed that offset distance X1 (FIG. 20A) represents a worst-case veneer edge misalignment distance for a given conventional plywood manufacturing process. As indicated in FIG. 21A, a strip 86-1 of panel material having a width W₈₆ which is equal to or greater than the worst-case veneer edge misalignment distance (e.g., greater than offset distance X1) must be removed from panel side edge 83-1 in order to provide panel side edge 83-1(T2) with the desired smooth (vertical plane) surface. Because it is not practical to measure the actual veneer edge misalignment offset distance occurring at every peripheral panel edge, conventional smoothing/processing operations require the removal of a strip of panel material having width W₈₆ equal to the worst-case veneer edge misalignment distance from panel side edge 84-2(T2), as indicated in FIG. 21B. Note that strips of material having a width similar to width W₈₆ must also be removed from each of the two end edges for similar reasons. Accordingly, each veneer must have a width dimension that is greater than the targeted width dimension by at least 2×W₈₆ (e.g., 4′ plus two times width W₈₆) and must have a length dimension that is greater than the targeted length dimension by a similar amount to reliably correct for worst-case veneer edge misalignment issues. The four strips removed during the smoothing/processing operation (described above with reference to FIG. 19) represent a significant amount of veneer (wood) material that is rendered unusable for plywood production (i.e., must be discarded). Therefore, conventional plywood manufacturing processes require the purchase or procurement of veneers having length/width dimensions that are significantly greater than the targeted length/width dimensions of the finished plywood panels to accommodate random veneer edge misalignments, and the strips removed from the four side edges represent wasted resources that significantly increase the total production cost of the plywood panels.

What is needed is a reliable and cost-effective system and method that is/are capable of producing high-quality plywood panels at a lower total production cost than that associated with conventional plywood manufacturing processes. More specifically, what is needed is a method, robotic end-tool and/or work cell that facilitate the automated assembly of wood veneers during plywood panel production in a way that substantially reduces the time, cost and wasted material associated with conventional post-assembly smoothing/processing operations.

### SUMMARY OF THE INVENTION

In an embodiment the present invention is directed to a method for producing plywood panels that reduces production time and cost by performing an automated veneer assembly (stacking) operation in which a selected side edge (i.e., one of the two opposing side edges) of each veneer layer is precisely vertically aligned with associated selected side edges of underlying veneer layers, and a selected end edge (i.e., one of the two opposing end edges) of at least some veneer layers is precisely vertically aligned with and associated end edge of an underlying (e.g., lowermost) veneer layer. The automated veneer stacking operation begins by placing a full-size lowermost (first outer) veneer into an assembly region (e.g., on a designated work bench surface or a conveyor belt surface). In some embodiments a sensor system is utilized to generate sensor data that specifies the positional locations (e.g., the horizontal coordinate position and/or rotational orientation) of the selected (first) side edge and selected (first) end edge of the lowermost veneer, and this sensor data is utilized (e.g., by way of a centralized control unit) to control one or more robot mechanisms during the placement (stacking) of subsequent veneer layers (e.g., two half-size veneers and then a second full-size veneer) on the lowermost veneer such that associated side edges of subsequently placed (stacked) veneer layer are precisely vertically aligned with the selected side edge of the lowermost veneer, and such that and associated end edge of the subsequently placed second full-size veneer is precisely vertically aligned with the selected end edge of the lowermost veneer. This automated veneer stacking operation generates veneer assemblies having four peripheral edges including an aligned panel end edge, which is collectively formed by the full-size veneer end edges, an opposing non-aligned panel end edge, which is collectively formed by the opposing veneer end edges, an aligned (first) panel side edge, which is collectively formed by the associated/selected (first) veneer side edges, an opposing non-aligned (second) panel side edge, which is collectively formed by the opposing (second) veneer side edges. Note that the non-aligned (second) panel side edge is generated by (i.e., a byproduct of) the automated veneer stacking operation because the width dimension (size) of wood veneers typically varies (i.e., for reasons described above), thereby typically producing a small difference in the width dimensions of each pair of successively stacked veneer layers, and this small difference necessarily produces a vertical misalignment of the opposing (second) veneer side edges when the selected (first) veneer side edges of two successively stacked veneer layers are vertically aligned.

Similarly, because the length dimensions of the veneers also typically vary, by controlling the relative horizontal position between the two successively stacked veneer layers such that selected (first) full-size veneer end edges are vertically aligned, any difference between the lengths of the two full-size veneer layers will necessarily produce a vertical misalignment at the opposing (second) veneer end edges. In effect, the automated veneer stacking operation localizes significant edge misalignment to two of the four peripheral panel edge sections of each veneer assembly (i.e., significant side edge misalignment only occurs along the non-aligned (second) panel side edge and is minimized along the aligned (first) panel side edge, and significant end edge misalignment occurs on the non-aligned (second) panel end edge and is minimized on the opposing aligned (first) panel end edge). After completing the automated veneer stacking operation, each veneer assembly then undergoes post-assembly processing that includes smoothing (e.g., grinding or otherwise abrading wood material from) the two side edges and the two end edges in a way that both planarizes (vertically aligns) these edges and adjusts the assembly's length and width to the equal the specified (target or standard) plywood panel dimensions. An advantage provided by this automated veneer stacking operation is that the amount of wasted wood (veneer) material removed during the post-assembly smoothing/processing operation is effectively reduced by approximately 50% over that produced by conventional plywood manufacturing processes because significant smoothing/processing operations are only needed to correct veneer edge misalignments occurring on the two non-aligned panel edges. That is, because the veneer edges forming the two aligned panel edges are precisely vertically aligned to form substantially planar surfaces during the stacking process, little or no material must be removed from the two aligned panel edges during post-assembly smoothing/processing. Moreover, because the smoothing/processing operation accounts for a significant portion of the total time and resources required to produce plywood panels using conventional methods, by reducing significant edge smoothing/processing to two of each panel's four peripheral edges (i.e., the two non-aligned edges), the plywood panel production method of the present invention is able to produce plywood panels at a substantially lower total production cost (i.e., in comparison to plywood panels produced using conventional methods).

In some embodiments a work cell utilizes a sensor system, at least one robot mechanism and a control unit to perform the automated veneer stacking operations mentioned above. The sensor system is configured to determine a location of the selected (first) side edge and the selected (first) end edge of each layer of veneers, and to generate sensor data specifying each determined edge location. The robot mechanism(s) is/are configured to assemble each plywood panel by sequentially: (i) moving a lowermost (first outer) veneer from an associated (first) supply region into a designated assembly region during a first assembly phase, (ii) moving intermediate veneers from a second supply region and placing/stacking the intermediate veneers onto the lowermost veneer during a second assembly phase, and (iii) moving an uppermost (second outer) veneer from either the first supply region or a third supply region and placing/stacking the uppermost veneer onto the two intermediate veneers during a third assembly phase. In some embodiments the first phase may be performed using a separate mechanism (i.e., other than the robot mechanism(s) utilized during the second and third assembly phases) to deliver the lowermost veneer into the designated assembly region, but this approach may undesirably increase work cell cost and complexity (i.e., in comparison to utilizing one or more robot mechanisms to move and place veneers during all three assembly phases). The control unit is configured to receive the sensor data from the sensor system and to control the veneer stacking operations performed by the robot mechanism such that the selected side and end edges of each veneer layer, which are placed during the second and third assembly phases, are precisely vertically aligned with the associated side and end edges of the lowermost veneer. Specifically, the control unit is configured to control the robot mechanism during the second and third assembly phases such that, during the second assembly phase, selected side edges of the two intermediate veneers are vertically aligned with the associated (first) side edge of the lowermost veneer and the selected end edge of one of the two intermediate veneers is vertically aligned with the associated (first) end edge of the first outer veneer, and, during the third assembly phase, the selected side edge of the uppermost veneer is vertically aligned with the associated (first) side edge of lowermost veneer and the associated side edges of the two intermediate veneers and the selected end edge of the uppermost veneer is vertically aligned with the associated (first) end edge of the lowermost veneer and the end edge of one of the two intermediate veneers. A work cell configured to operate in this manner is able to perform the veneer stacking operation (described above) in a completely automated manner, thereby facilitating the plywood production method and associated advantages mentioned herein.

In an embodiment a robotic end-tool (end-of-arm tooling) includes vacuum grippers and cameras that are mounted on a frame in an arrangement that facilitates performing the above-mentioned automated veneer stacking operation (i.e., in conjunction with a 6-axis robot or other articulated robot). The frame includes an elongated spar having a length comparable to the length of a full-size veneer, with a central region (e.g., center point) of the spar being connected to the robot's end-shaft (distal end portion) by way of a central hub fixture such that the spar is maintained in a horizontal orientation throughout the automated veneer stacking operation. Multiple horizontal cross-ribs extend perpendicular to the elongated spar, each having a length comparable to the width of a veneer and having a center point that is fixedly connected to the elongated spar. In a practical embodiment the end-tool includes four cross-ribs, with first and second ribs disposed on one side of the central hub fixture and third and fourth ribs disposed on the other side of the central hub fixture. The vacuum grippers are connected to the cross-ribs and disposed in a horizontal plane below the elongated spar. Each of the vacuum grippers includes an elongated box-like housing having a closed upper end that is connected to an associated cross-rib and a downward-facing open end that is surrounded by a gasket seal and is operably coupled to a vacuum supply (e.g., coupled to a vacuum pump by way of a vacuum supply line). In practical embodiments the interior of each vacuum gripper housing is divided into multiple vacuum cavities, where each vacuum cavity is configured to independently secure an associated region of a veneer's upper surface by way of a downward-facing opening portion and is coupled to the vacuum supply by way of an associated isolation valve. In some embodiments, two vacuum grippers are connected to each cross-rib such that their respective elongated housings are aligned in opposing diagonal directions (i.e., relative to the elongated spar), with the four vacuum grippers disposed on each side of the central hub fixture being arranged to form an associated X-shaped pattern. The cameras are fixedly connected to the frame (e.g., by way of rods/fixtures attached to the cross-ribs) in a vertical orientation (i.e., such that each camera's lens is aimed downward) and positioned to capture image data that can be used to determine the location/orientation of selected side/end edges of the veneer(s) secured to the end-tool by the vacuum grippers, and to control the robot mechanism during stacking operations such that the selected side/end edges are aligned with corresponding side/end edges of underlying veneers. In an exemplary embodiment, first cameras are positioned and arranged to image one or more of the veneer side edges and second cameras are positioned and arranged to image one or more of the veneer end edges. In some embodiments, one or more additional cameras are positioned and arranged over a central region of the end-tool to facilitate the simultaneous securing/transfer of half-size veneers. By providing an end-tool with the above-mentioned frame, vacuum gripper and camera arrangement, the present invention facilitates maintaining one full-size or two half-size veneers in a horizontal orientation with a high degree of efficiency and reliability while being transferred from a veneer supply region to an assembly region, and further facilitates the generation of image (sensor) data that can be utilized to accurately align the selected side and end edges of stacked veneer layers during the automated veneer stacking operation.

In some embodiments, a robotic work cell utilizes a control unit to coordinate the operations of one or more robot mechanisms with the operations of other automated work structures during each automated veneer stacking operation. Each robot mechanism includes an articulated robot and an end-tool having cameras and vacuum grippers mounted on a frame in the manner described above. Image data generated by the cameras may be collected and processed by an image system before being used by the control unit to control the articulated robot. One or more supply conveyors may be controlled by the control unit to position stacks of full-size and half-size veneers in associated supply regions. A vacuum system may be controlled by the control unit to supply suction force to the vacuum grippers to facilitate pick-and-place-type transfers of the veneer(s) from the associated supply regions to a designated assembly region (e.g., the upward-facing surface of a work bench or other suitable assembly structure). An automated glue applicator mechanism may be positioned adjacent to the assembly region and controlled by the control unit to apply a layer of glue (adhesive) between successively stacked veneer layers located in the assembly region (e.g., a first glue layer applied to the upward facing surface of the lowermost (first outer) veneer at the end of the first assembly phase, and a second glue layer applied to the upward facing surfaces of the two intermediate veneers at the end of the second assembly phase). An assembly conveyor and associated transfer mechanism may be controlled by the control unit to move assembled plywood panels away from the assembly region at the end of each automated veneer stacking operation.

In some embodiments the vision-based sensor system (vision system) utilizes cameras mounted on the end-tool (as described above) to generate image data corresponding to at least two of the four peripheral edges of each stacked veneer. In presently preferred embodiments, each of the camera is a three-dimensional (3D) time-of-flight camera/sensor, but in some embodiments one or more of the cameras may be implemented using a line sensor. An advantage of utilizing 3D time-of-flight cameras (e.g., instead of line sensors) is that image data generated as the end-tool is maneuvered to pick up a veneer may be used to generate a 3D point cloud that can be used to better approximate the veneer's shape and detect undesirable flaws/defects (e.g., chips or other missing sections) in the veneer's peripheral edges. In some embodiments the image data may be pre-processed by a vision-system-to-controller interface circuit, and the preprocessed data is then passed to a central processor of control unit for use in generating the control signals sent to the robot mechanism. In some embodiments the vision-based system may also utilize one or more stationary cameras (i.e., not affixed to the end-tool) to generate image data pertaining to other aspects related to the automated veneer stacking operation (e.g., the number and quality of veneers in each supply region/stack, the presence of potentially dangerous or damaging obstacles in the work area, etc.). In an alternative embodiment a vision-based system may utilize one or more stationary cameras (i.e., cameras not affixed to the end-tool) to detect the location of selected veneer side/end edges of both previously placed/stacked veneer layers and next-to-be-placed veneer layer(s) (i.e., one full-size veneer or two half-size veneers that is/are secured by way of vacuum grippers to the end-tool), provided such an arrangement is capable of generating corresponding image (sensor) data that can be utilized to control an articulated robot such that the next-to-be-placed veneer(s) is placed/stacked such that the desired side/end edge alignment is achieved with sufficient precision.

In some embodiments the vacuum system utilizes one or more vacuum generators (pumps) that are operably configured to transmit low pressure (vacuum) to each vacuum gripper (e.g., by way of one or more vacuum supply lines that extend along the arm of the articulated robot). With this arrangement, the control unit actuates the vacuum generator(s) when the vacuum grippers are lowered onto the upper surface of a veneer, thereby supplying low pressure to the vacuum grippers that allows the robot mechanism to secure and move the veneer to the designated assembly region, and then the control unit de-activates the vacuum generator(s) to release the veneer, thereby enabling the robotic end-tool to secure and move full-size veneers during the first and third assembly phases. In some embodiments, two vacuum generators are independently controlled by the control unit to facilitate securing two half-size veneers from a single stack during the second assembly phase, where the first vacuum generator supplies low pressure to the four vacuum grippers forming one of the X-shaped patterns while securing/moving one of the half-size veneers, and the second vacuum generator supplies low pressure to the four vacuum grippers forming the other X-shaped pattern while securing/moving the second half-size veneer. In other embodiments, control valve(s) may be used to direct low pressure from a single vacuum source to multiple vacuum grippers, or each of the vacuum grippers may include its own vacuum supply unit that generates the required suction force in response to control signals transmitted from the control unit.

In some embodiments a plywood production work cell includes various work structures that serve to further automate the assembly process. In some embodiments supply conveyors are positioned and controlled by the control unit to move stacks of full-size and half-size veneers into corresponding supply regions (i.e., locations that can be accessed by the robot mechanism(s) during the assembly process). In some embodiments, a work bench (or other stationary assembly structure) is configured to provide a suitable assembly region/surface onto which the veneers are stacked, and includes a glue applicator mechanism configured to apply a glue layer onto an upward-facing surface of the lowermost veneer between the first and second assembly phases, and to apply another glue layer onto upward-facing surfaces of the two intermediate veneers between the second and third assembly phases. An optional assembly conveyor may be provided to receive and transfer completed veneer assemblies from the work bench to post-assembly processing equipment.

In some embodiments a plywood production work cell utilizes two or more robot mechanisms to move veneers between corresponding supply regions and one or more designated assembly regions during automated veneer stacking operations, thereby reducing the time required to assembly plywood panels in comparison to single-robot approaches. In these embodiments, each robot mechanism includes an articulated robot and an associated end-tool that are configured and operate in a manner similar to that described above, and the work cell's control unit coordinates operations of the two or more robot mechanisms during each automated veneer stacking operation to generate veneer assemblies having opposing aligned and non-aligned end and/or side panel edges. In some embodiments, plywood production work cells include two or more robot mechanisms that are configured to respectively move full-size and half-size veneers between corresponding supply regions and a stationary assembly region during automated veneer stacking operations. An advantage of such stationary assembly region work cells is that they can be relatively easily modified (e.g., by way of modifying the software controlling the robot mechanisms) to produce plywood panels having any number of veneer layers (e.g., three, four, five, seven . . . ). In other embodiments, plywood production work cells utilize three or more robot mechanisms and two or more glue applicator mechanisms that are arranged in series along the sides of a conveyor-type assembly structure to produce plywood panel assemblies in an assembly-line-type manner. Although these assembly-line-type work cells require a greater number of robot mechanisms and it may be more difficult to reconfigure these work cells to produce plywood panels having different numbers of veneer layers, assembly-line-type work cells are typically able to generate plywood panels at a substantially higher production rate (i.e., a greater number of plywood panels per hour) than any of the approaches mentioned above. Note that, in each of the above-mentioned embodiments, the work cell's control unit utilizes image data generated by cameras mounted on the various end-tools to coordinate operations of the multiple robotic mechanisms such that the selected veneer side edges and at least some of the veneer end edges are precisely aligned, thereby generating veneer assemblies having the aligned side/end edges described herein. In some embodiments, a plywood production work cell utilizes multiple robot mechanisms to place half-size intermediate veneers in a continuous end-to-end arrangement that forms one or more continuous intermediate veneer layers sandwiched between pairs of edge-aligned full-size veneers. That is, unlike previous embodiments in which a selected end edge of one of two intermediate veneers is aligned with the selected end edge of the lowermost full-size veneer, the work cells are configured to sequentially place the intermediate veneers such that a first end edge of each intermediate veneer is aligned with (e.g., abuts/contacts) a corresponding end edge of a first adjacent intermediate veneer and a second end edge of said each intermediate veneer is aligned with a corresponding end edge of a second adjacent intermediate veneer, thereby forming a continuous intermediate layer with said each intermediate veneer being disposed between the first and second adjacent intermediate veneers. Although this arrangement may require modified post-assembly processing (e.g., a flying saw cut) that is not needed by the aligned-end-edge approaches described above, the continuous intermediate veneer layer arrangement may be advantageous in some applications. For example, the continuous intermediate veneer layer arrangement may facilitate the production of four-layer plywood panels in less time and with less wasted material (i.e., in comparison to producing four-layer plywood panels by way of the aligned-end-edge approaches described above).

### BRIEF DESCRIPTION OF THE DRAWINGS

These and other features, aspects and advantages of the present invention will become better understood with regard to the following description, appended claims, and accompanying drawings, where:

FIG. 1 is a perspective view showing a plywood assembly work cell during an automated veneer stacking operation according to a simplified embodiment of the present invention;

FIG. 2 is a flow diagram showing a plywood production method according to another embodiment of the present invention;

FIG. 3A is a perspective view showing an exemplary three-layer veneer assembly during a post-assembly smoothing/processing operation of the plywood production method of FIG. 2 according to a simplified exemplary embodiment;

FIG. 3B is a perspective view showing an exemplary final three-layer plywood panel produced by the plywood production method of FIG. 2 according to an embodiment;

FIGS. 4A and 4B are cross-sectional side views showing exemplary opposing side edges of the veneer assembly of FIG. 3A before the post-assembly smoothing/processing operation;

FIGS. 5A and 5B are cross-sectional side views showing exemplary opposing side edges of the plywood panel of FIG. 3B after the post-assembly smoothing/processing operation;

FIG. 6A is a perspective view depicting a robotic end-tool utilized by a plywood production work cell according to an embodiment;

FIG. 6B is a cross-sectional side view taken along section line 6B-6B of FIG. 6A and depicts a vacuum gripper before securing a wood veneer during an automated veneer stacking operation;

FIG. 7 is a perspective view showing a plywood production work cell including the robotic end-tool of FIG. 6A according to an embodiment;

FIGS. 8A and 8B are diagrams depicting exemplary control connections between a control unit and various systems implemented by the work cell of FIG. 7;

FIGS. 9A, 9B, 9C, 9D, 9E and 9F are cross-sectional side views depicting a portion of a vacuum system of the plywood assembly work cell of FIG. 7 during an exemplary veneer stacking operation;

FIGS. 10A, 10B, 10C, 10D, 10E, 10F, 10G, 10H and 10I are simplified top views showing the plywood assembly work cell of FIG. 6 during an automated veneer stacking operation according to another embodiment;

FIG. 11 is a top view showing a plywood assembly work cell according to another exemplary embodiment;

FIG. 12 is a top view showing a plywood assembly work cell according to another exemplary embodiment;

FIG. 13 is a top view showing a plywood assembly work cell according to another exemplary embodiment;

FIGS. 13A and 13B are top views showing robotic end-tools utilized by a plywood production work cell of FIG. 13 according to an embodiment;

FIGS. 14A, 14B and 14C are partial cross-sectional side views showing portions of the plywood production work cell of FIG. 13 during operation;

FIG. 15 is an exploded perspective view showing a four-ply panel assembly according to an exemplary embodiment;

FIGS. 16A, 16B and 16C are partial cross-sectional side views showing portions of a plywood production work cell modified to produce the four-ply panel assembly of FIG. 15 according to another embodiment;

FIG. 17 is a simplified perspective view depicting a conventional method for generating wood veneers;

FIGS. 18A and 18B are exploded and assembled perspective views, respectively, depicting the assembly of an exemplary plywood panel;

FIG. 19 is a simplified perspective view depicting a peripheral edge smoothing process performed during a conventional plywood manufacturing process;

FIGS. 20A and 20B are cross-sectional side views respectively depicting opposing side edges of the plywood panel of FIG. 19 before a peripheral edge smoothing/processing operation; and

FIGS. 21A and 21B are cross-sectional side views respectively depicting the opposing side edges of the plywood panel of FIG. 19 after the peripheral edge smoothing/processing operation.

### DETAILED DESCRIPTION OF THE DRAWINGS

The present invention relates to an improvement in robotic work cells utilized to process bulk objects. The following description is presented to enable one of ordinary skill in the art to make and use the invention as provided in the context of a particular application (i.e., placing brand labels on promotional hand sanitizer bottles) and its requirements. As used herein, directional terms such as “upper”, “lower”, “uppermost”, “lowermost”, “upward”, “downward”, “above”, “below”, “horizontal” and “vertical” are intended to provide relative positions for purposes of description and are not intended to designate an absolute frame of reference unless otherwise specified in the appended claims. Similarly, although the Z-axis arrows utilized in the various figures consistently depict a vertical direction, the X-and Y-axis arrows utilized to depict horizontal directions may differ in the various figures (i.e., the X- and Y-axes may be rotated around the Z-axis direction) for descriptive purposes. Parenthetical time-based suffixes (e.g., “(T11)” and “(T12)”) are utilized in the figures and description below to indicate certain objects or features at sequentially different points in time during the operation of an exemplary work cell of the present invention. Similar time-based suffixes may be used to indicate relative positions of robot mechanisms and other structures/features during the operation of an exemplary work cell. Note that plywood panels generated in accordance with the present invention are substantially the same as those generated using conventional methods—therefore, for clarity and convenience, reference numbers that are utilized to identify various veneer and plywood panel features in the background section (e.g., “80” to indicate veneer assemblies, “55-1” and “55-2” to indicated the lowermost and uppermost full-size veneers in a three-layer panel) are also utilized to describe similar structures and plywood panel features generated in accordance with the present invention. For descriptive purposes, the phrase “veneer assembly” is utilized herein to identify the incomplete plywood panels generated by the automated veneer assembly operation described below (i.e., before completion of the post-assembly processing required to generated finished plywood panels that are ready for sale or use). In some instances, the term “panel” may be utilized to describe some or all of a veneer assembly, but such instances are to be read in context and do not necessarily refer to features of a finished plywood panel. Various modifications to the preferred embodiment will be apparent to those with skill in the art, and the general principles defined herein may be applied to other embodiments. Therefore, the present invention is not intended to be limited to the embodiments shown in the figures and/or described below but is to be accorded the widest scope consistent with the principles and novel features herein disclosed.

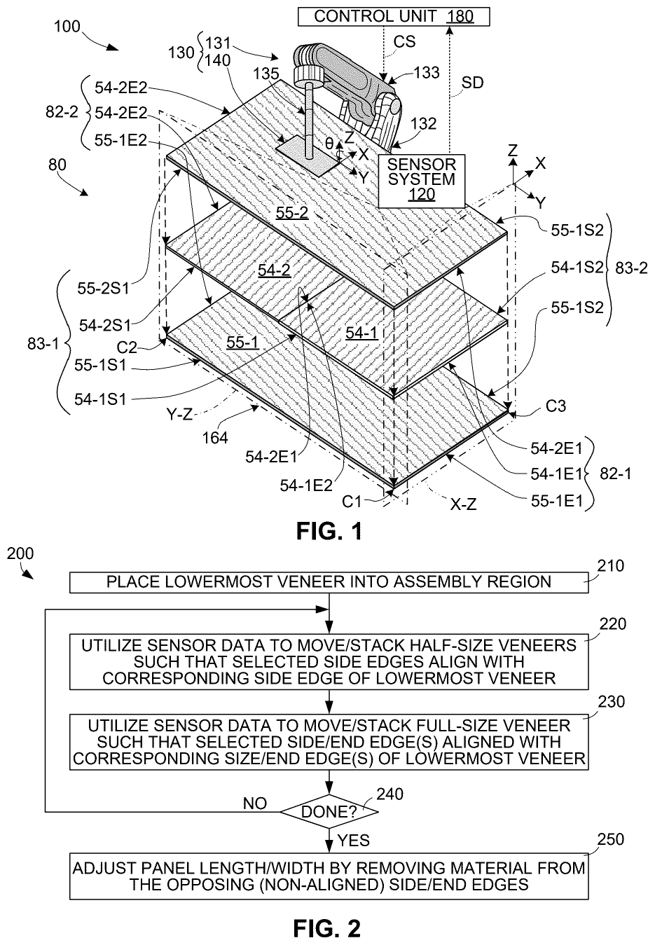

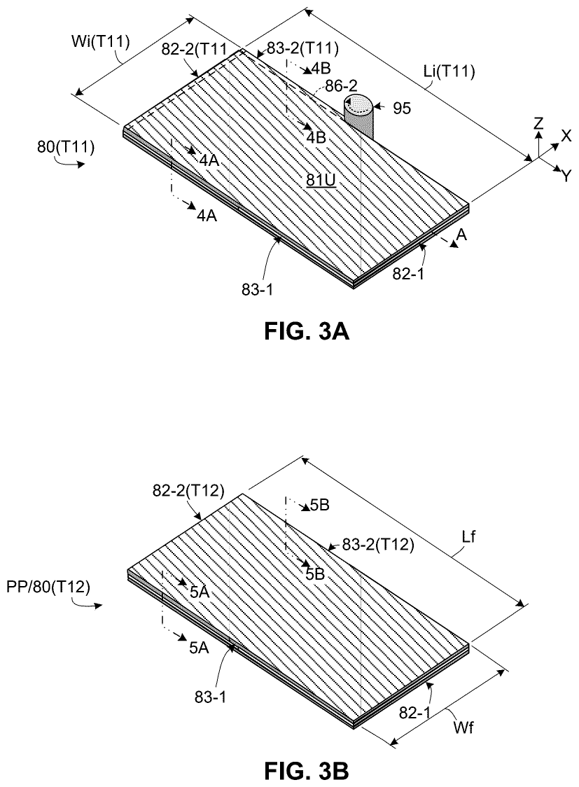

FIGS. 1 and 3A depict an exemplary three-layer assembly 80 in exploded and assembled forms, respectively. As described in additional detail below with reference to FIGS. 2, 3A and 3B, assembly 80 is generated during an automated veneer assembly operation that forms part of a plywood production method utilized to produce a corresponding finalized plywood panel PP (shown in FIG. 3B). As depicted in FIG. 1, assembly 80 is generated by stacking two intermediate veneers 54-1 and 54-2 on a lowermost (first outer) veneer 55-1 and then stacking an uppermost (second outer) veneer 54-2 on intermediate veneers 54-1 and 54-2 (i.e., such that intermediate veneers 54-1 and 54-2 are sandwiched between lowermost veneer 55-1 and uppermost veneer 55-2). Each veneer has an associated four-sided (quadrilateral) peripheral edge including two opposing (parallel) side edges and two opposing end edges. To distinguish the opposing side and end edges in the description below, one edge of each parallel set of edges is referred to as “selected” and the other is referred to as “opposing”. For example, parallel side edges 55-1S1 and 55-1S2 of lowermost veneer 55-1 are referred to as selected (first) side edge 55-1S1 and opposing (second) side edge 55-1S2, and parallel end edges 55-1E1 and 55-1E2 of lowermost veneer 55-1 are referred to as selected (first) end edge 55-1E1 and opposing (second) end edge 55-1E2. Similarly, uppermost veneer 55-2 has selected/opposing side edges 55-2S1 and 55-2S2 and selected/opposing end edges 55-2E1 and 55-2E2, intermediate veneer 54-1 has selected/opposing side edges 54-1S1 and 54-1S2 and selected/opposing end edges 54-1 E1 and 54-1E2, and intermediate veneer 54-2 has selected/opposing side edges 54-2S1 and 54-2S2 and selected/opposing end edges 54-2E1 and 54-2E2. Note that the size of intermediate veneers 54-1 and 54-2 is one-half that of uppermost veneer 55-1 and lowermost veneer 55-2, whereby intermediate veneers are sometimes referred to herein as “half-size” veneers that, when placed end-edge-to-end-edge (as indicated in FIG. 1), have a combined periphery that substantially matches the peripheral edges of “full-size” outer veneers 55-1 and 55-2. Note also that the phrase “veneer layer” is used herein to generically individually refer either a full-size veneer (i.e., uppermost veneer 55-1 or lowermost veneer 55-2) or an associated group (e.g., pair) of intermediate veneers 54-1 and 54-2. In the example shown in FIGS. 1 and 3A, full-size veneers 55-1 and 55-2 respectively form uppermost and lowermost veneer layers of three-layer assembly 80, and intermediate veneers 54-1 and 54-2 are coplanar and therefore collectively form a middle veneer layer of three-layer assembly 80. As indicated in FIGS. 1 and 3A, when the outer and intermediate veneer layers are assembled in a stack, associated veneer side edges and veneer end edges collectively form the side and end edges of assembly 80. For example, veneer side edges 55-1S1, 54-1S1, 54-2S1 and 55-2S1 form a first panel side edge 83-1 of assembly 80. Similarly, associated veneer side edges 55-1S2, 54-1S2, 55-2S2 and the second side edge of intermediate veneer 54-2 (which is obscured in FIG. 1 by uppermost veneer 55-2) collectively form a second panel side edge 83-2, associated veneer end edges 55-1E1, 54-1E1 and 55-2E1 form a first panel end edge 83-1, and associated veneer end edges 55-1E2, 54-2E2 and 55-2E2 form a second panel end edge 83-2. Although the work cells and methods of the present invention are described with specific reference to three-layer plywood panels, those skilled in the art will understand that the work cells and methods described below may be modified to produce plywood panels having any number of veneer layers.

FIG. 1 also shows a simplified robotic work cell 100 that utilizes a sensor system 120, a robot mechanism 130 and a control unit 180 to perform the automated veneer assembly (stacking) operation in which selected side and end edges of the stacked veneer layers are precisely aligned during the stacking process. Sensor system 120 is configured and functions to determine the location (i.e., X-Y-Z position and/or rotational orientation) of one side edge and one end edge of each veneer, and to generate sensor data SD that operably conveys the edge location information to control unit 180. More specifically, sensor system 120 utilizes one or more sensors (e.g., digital cameras or other sensors) to determine the location (i.e., X-Y position and rotational orientation θ) of side edge 55-1S1 and end edge 55-1E1 of lowermost veneer 55-1, side edges 55-1S1 and 55-2S1 and end edge 55-1S1 of intermediate veneers 54-1 and 54-2, and side edge 55-2S1 and end edge 55-2E1 of uppermost veneer 55-2, and to generate sensor data SD indicating each determined location. Robot mechanism 130 includes a multi-axis robot 131 and a robotic end-tool 140, which is connected to a distal end portion 135 of multi-axis robot 131. End-tool 140 is configured to secure lowermost veneer 55-1, intermediate veneers 54-1 and 54-2 and uppermost veneer 55-2 during corresponding phases of the automated veneer stacking operation so that the veneers can be sequentially moved by multi-axis robot 131 from one or more supply regions (not shown in FIG. 1) into an assembly region 164 in the manner described below. As generally depicted and explained in further detail below, control unit 180 utilizes sensor data SD received from sensor system 120 to control robot mechanism 130 (e.g., by way of control signals CS) during the assembly of each plywood panel such that corresponding side edges 55-1S1, 54-1S1, 54-2S1 and 55-2S1 are precisely vertically aligned with each other (e.g., such that each corresponding side edge is disposed in a vertical plane Y-Z), and such that corresponding end edges 55-1E1, 54-1E1, 54-2E1 and 55-2E1 are precisely vertically aligned with each other (e.g., such that each corresponding end edge is disposed in a vertical plane X-Z).

FIG. 2 includes a flow diagram depicting a generalized plywood panel production method 200 according to an embodiment. Blocks 210 to 230 of plywood panel production method 200 correspond to the automated veneer stacking (assembly) operation that may be performed, for example, using work cell 100 (mentioned above with reference to FIG. 1), and block 250 corresponds to post-assembly processing, and more particularly to processing the non-aligned panel edges using, for example, a router or other processing equipment positioned adjacent to work cell 100 (not shown in FIG. 1). Note that pre-assembly operations (i.e., operations performed before beginning the automated veneer stacking operation, such as the generation of full-size and half-size wood veneers) may be performed using conventional methods and are therefore omitted from the description of plywood panel production method 200 for brevity. Note also that post-assembly operations are not restricted to smoothing/processing of the non-aligned edges.

Referring to block 210 (top of FIG. 2) a first assembly phase of the automated veneer stacking operation includes moving/placing a lowermost (first outer) veneer into a designated assembly region. Referring to FIG. 1, the first assembly phase may include placing the lowermost veneer (i.e., a single full-size veneer) into a designated assembly region 164, which may be a horizontal (flat) upper surface of a work bench, a conveyor belt or another suitable assembly structure. In some embodiments a sensor system (e.g., sensor system 120, shown in FIG. 1) may be utilized to generate sensor data that identifies and stores the location (i.e., X-Y position and/or rotational orientation) of a selected side edge 55-1S1 and a selected end edge 55-1E1 of the lowermost veneer 55-1 (i.e., identifying the selected edge locations after lowermost veneer has been placed into assembly region 164). For example, the sensor data may identify the X-Y locations of corner C1 (i.e., the shared end point of side edge 55-1S1 and end edge 55-1E1 of lowermost veneer 55-1, shown in FIG. 1), corner C2 (i.e., the second end point of side edge 55-1S1) and corner C3 (i.e., the second end point of end edge 55-1E1). This sensor data may be stored and utilized to control one or more robot mechanisms (e.g., multi-axis robot 131, FIG. 1) during subsequent assembly phases of the automated veneer stacking operation (i.e., such that robot mechanism 130 places each subsequent veneer layer with the end points of the corresponding side/end edges located at the stored corner locations). In some embodiments, this first assembly phase is performed using the same robot mechanism (e.g., robot mechanism 130, described above with reference to FIG. 1) as that utilized during subsequent assembly phases, where robot mechanism 130 is configured to move lowermost (first outer) veneer 55-1 from a first supply region (not shown) to designated assembly region 164 (see FIG. 1). In other embodiments, the first assembly phase may be implemented using a separate mechanism (i.e., other than robot mechanism 130) capable of moving (e.g., sliding) lowermost veneer 55-1 into assembly region 164, and robot mechanism 130 is utilized to perform the second and third assembly phases (described below). As described in the more detailed embodiments set forth below, a glue (adhesive) layer may be applied to an upper surface of the lowermost veneer at the end of the first assembly phase.

Referring to block 220, a second assembly phase involves utilizing sensor data to control at least one robot mechanism such that the robot mechanism places two or more intermediate (e.g., half-size) veneers on the lowermost veneer such that associated side edges of the two intermediate veneers are vertically aligned with the selected side edge of the lowermost veneer. In some embodiments, the second assembly phase also involves utilizing sensor data to control the robot mechanism such that an associated end edge of one of the intermediate veneers is vertically aligned with the selected end edge of the lowermost veneer. Referring to FIG. 1, the second assembly phase generally involves placing intermediate veneers 54-1 and 54-2 onto lowermost veneer 55-1 such that both side edges 54-1S1 and 54-2S1 of intermediate veneers 54-1 and 54-2 are vertically aligned with selected side edge 55-1S1 of lowermost veneer 55-1, and that end edge 54-1E1 of intermediate veneer 54-1 is vertically aligned with selected end edge 55-1E1 of lowermost veneer 55-1. Note that this stacking arrangement also requires that the corner shared by end edge 54-1E1 and side edge 54-1S1 of veneer 54-1 is vertically aligned with corner C1 of lowermost veneer 55-1.

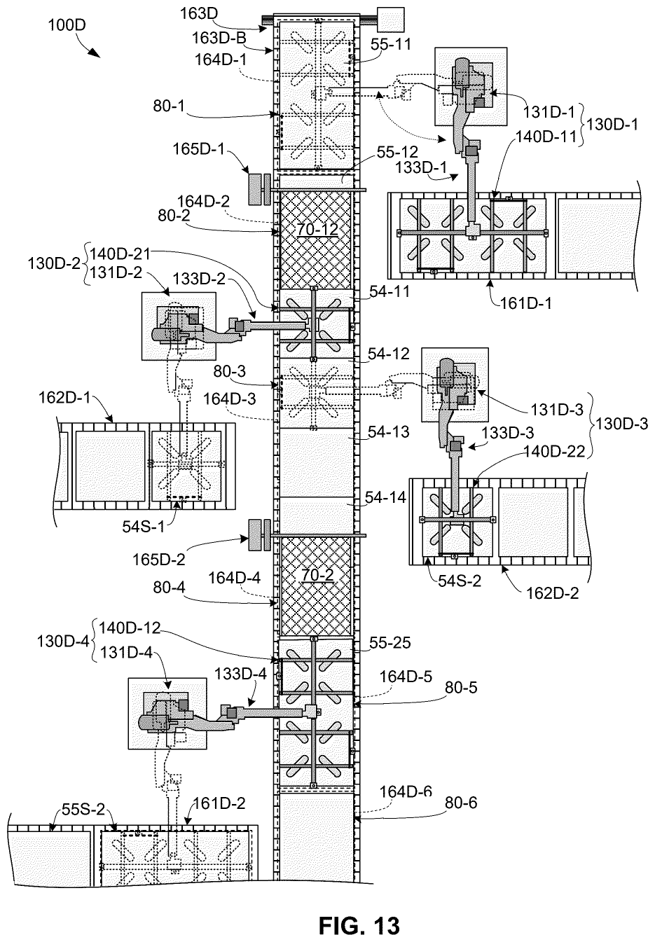

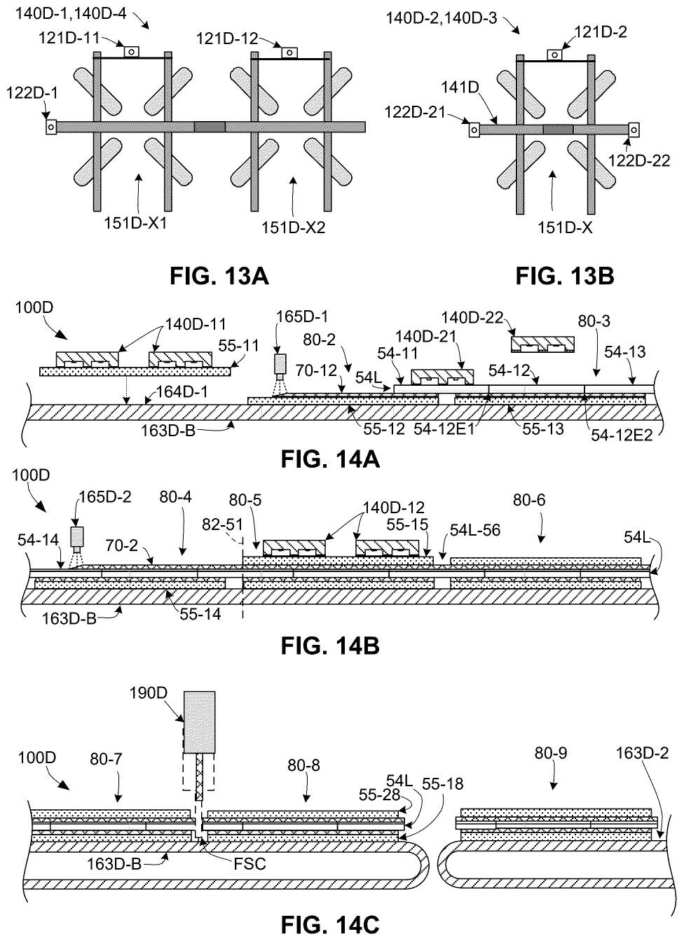

Note also that intermediate veneers 54-1 and 54-2 are placed in an abutting (or substantially abutting) arrangement (i.e., such that end edge 54-1E2 of veneer 54-1 abuts or is very close to end edge 54-2E1 of veneer 54-2). Various techniques may be utilized to control robot mechanism 130 in order to achieve alignment of the selected side and end edges. For example, current (real time) sensor data may be generated that identifies the locations of the selected side and end edges of intermediate veneers 54-1 and 54-2 and may be utilized in conjunction with stored sensor data, which identifies the locations of the selected side/end edges of lowermost veneer 55-1, to control robot mechanism 130 such that intermediate veneers 54-1 and 54-2 are placed on lowermost veneer 55-1 with the required edge alignment. Alternatively, current sensor data may be generated that identifies the locations of the selected side and end edges of both lowermost veneer 55-1 and intermediate veneers 54-1 and 54-2, and this sensor data is utilized to control robot mechanism 130 such that intermediate veneers 54-1 and 54-2 are placed on lowermost veneer 55-1 with the required edge alignment. In each of these examples, sensor data is utilized to control robot mechanism 130 such that intermediate veneers 54-1 and 54-2 are positioned and placed on lowermost veneer 55-1 with the required edge alignment. In some embodiments (e.g., as described below with reference to FIGS. 13 to 16C), it may be advantageous to place intermediate veneers such that their selected side edges (e.g., side edges 54-1S1 and 54-2S1) are vertically aligned with selected side edge 55-1S1 of lowermost veneer 55-1, but such that the selected end edge of each intermediate veneer abuts the opposing end edge of a previously placed (i.e., such that selected end edge 54-1S1 of intermediate veneer 54-1 is not necessarily vertically aligned with selected end edge 55-1E1 of lowermost veneer 55-1).

Referring to block 230, a third assembly phase involves utilizing sensor data to control at least one robot mechanism such that the robot mechanism places a second full-size veneer on the two intermediate veneers with an associated side edge of the second full-size veneer vertically aligned with the selected side edge of the lowermost veneer (and corresponding side edges of the intervening veneers), and with an associated end edge of the second full-size veneer vertically aligned with the selected end edge of the lowermost veneer. In the case where the automated veneer stacking operation is utilized to produce three-layer veneer assemblies (e.g., assembly 80 shown in FIG. 1), the third assembly phase involves placing uppermost (second outer) veneer 55-2 onto intermediate veneers 54-1 and 54-2 such that side edges side edge 55-2S1 is vertically aligned with side edges 54-1S1 and 54-2S1 of intermediate veneers 54-1 and 54-2 and side edge 55-1S1 of lowermost veneer 55-1, and such that end edge 55-2E1 of uppermost veneer 55-2 is vertically aligned with end edge 55-1E1 of lowermost veneer 55-1. Note that, in cases where intermediate veneer 54-1 is placed such that end edge 54-1E1 is vertically aligned with end edge 55-1E1 of lowermost veneer 55-1, uppermost veneer 55-2 is placed such that end edge 55-2E1 is vertically aligned with end edge 54-1E1 of intermediate veneer 54-1. Alignment of the selected side and end edges may be achieved using sensor data in a manner similar to that described above with reference to block 220.

An optional decision block 240 is implemented after completion of the third assembly phase and may be utilized to facilitate the production of plywood panels having three, five, seven or more veneer layers. Decision block 240 may be omitted in cases where plywood panel production method 200 is only utilized to produce assemblies for three-layer plywood panels (e.g., assembly 80 shown in FIG. 1). That is, in the three-layer case the second full-size veneer placed during the third assembly phase (i.e., during a first iteration of block 230) forms the uppermost (second outer) veneer of the completed veneer assembly, whereby the automated veneer stacking operation is completed each time decision block 240 is encountered, and control passes along the YES branch from decision block 240 to block 250. In cases where the automated veneer stacking operation is used in the production of plywood panels having more than three layers (e.g., in the production of five-layer or seven-layer plywood panels), the second full-size veneer placed during the first iteration of block 230 represents an intermediate veneer within the veneer stack, and control passes along the NO branch from decision block 240 to block 220 at the end of the first iteration, whereby the veneer stacking operations performed in blocks 220 and 230 would be repeated until the desired number of layers was achieved. For example, in the case of a five-layer plywood panel, the second full-size veneer would form a central veneer of the completed veneer assembly, and an uppermost (second outer) veneer would be implemented by a third full-size veneer that would be placed/stacked during a second iteration of block 230, and the second iteration of decision block 240 would pass control along the YES branch to block 250.

Likewise, to produce plywood panels having more than five veneer layers, control would pass from decision block 240 along the NO branch to block 220 and the assembly operations of blocks 220 and 230 would be repeated until the required veneer layer count was achieved. In the context of plywood panels having more than three layers, the phrase “second assembly phase” may apply to any of the iterations of block 220, and “third assembly phase” may apply any of the iterations of block 230.

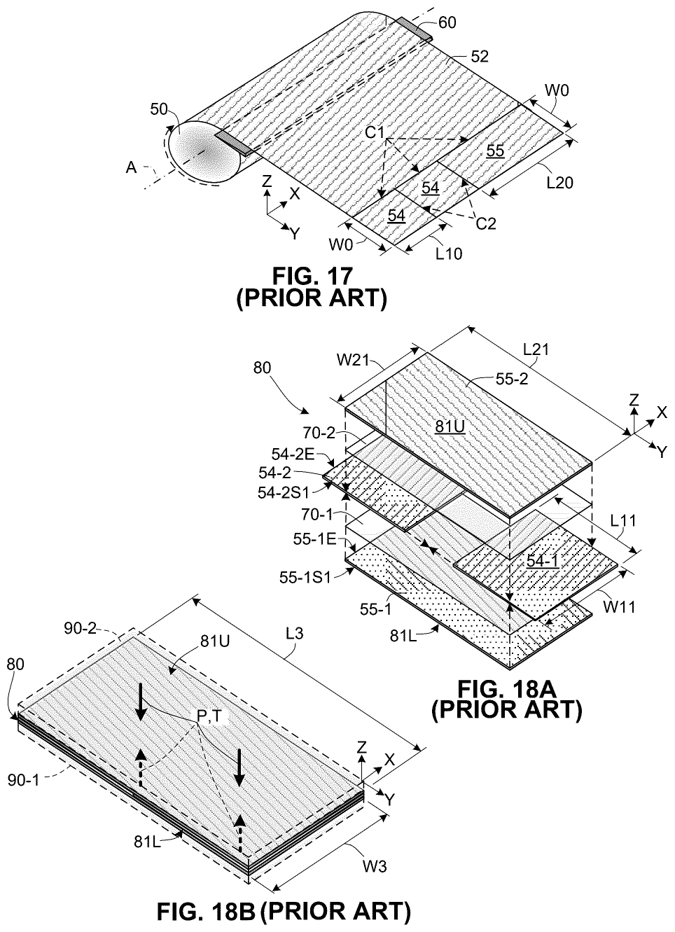

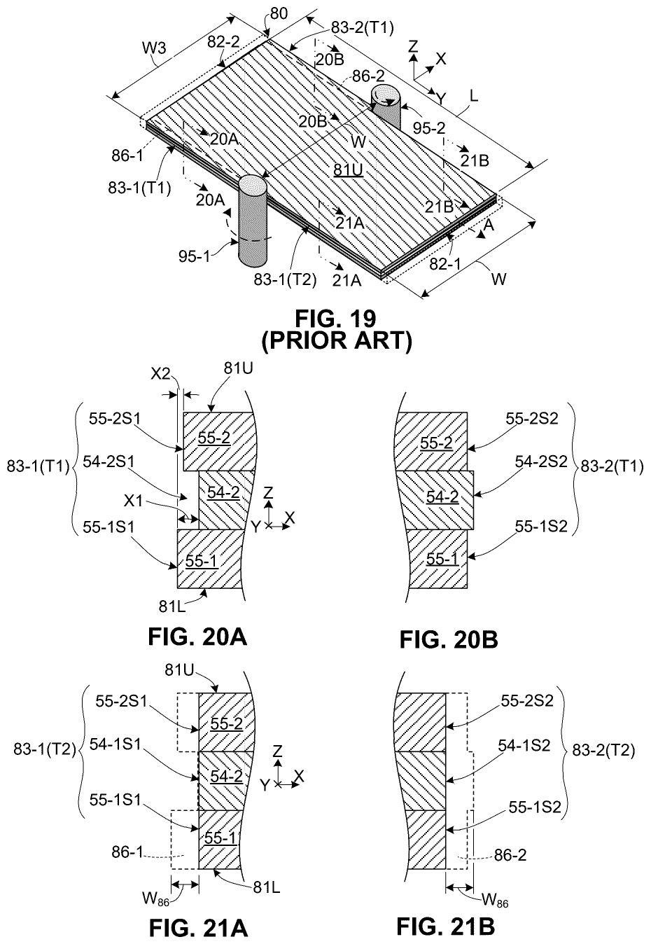

Referring to the lower portion of FIG. 2, plywood panel production method 200 concludes by performing post-assembly operations on the stacked veneer assemblies generated by the automated veneer stacking operation. As described in additional detail below, these post-assembly operations include (block 250) processing the non-aligned panel edges to both remove (trim) excess veneer material and to smooth/planarize the edge surfaces such that the veneer assembly achieves the targeted (specified) length and width of the finished plywood panel. In some embodiments, the post-assembly operations also include a glue curing operation involving the application of pressure and heat (e.g., as described above with reference to FIG. 18B) before performing the smoothing/processing operation. In some embodiments, post-assembly operations may include additional processes (e.g., applying paint or other coating to the peripheral panel edges and/or upper and lower panel surfaces. Therefore, unless otherwise specified in the appended claims, post-assembly operations are not limited to the non-aligned panel edge smoothing/processing operations described below.

FIG. 3A depicts assembly 80 at a time T11 during an exemplary smoothing/processing operation, and FIG. 3B depicts a finished plywood panel PP at a subsequent time T12 (i.e., after assembly 80 has been subjected to the smoothing/processing operation and all other post-assembly processing operations are completed, the fully processed assembly 80 is referred to as finished plywood panel PP).

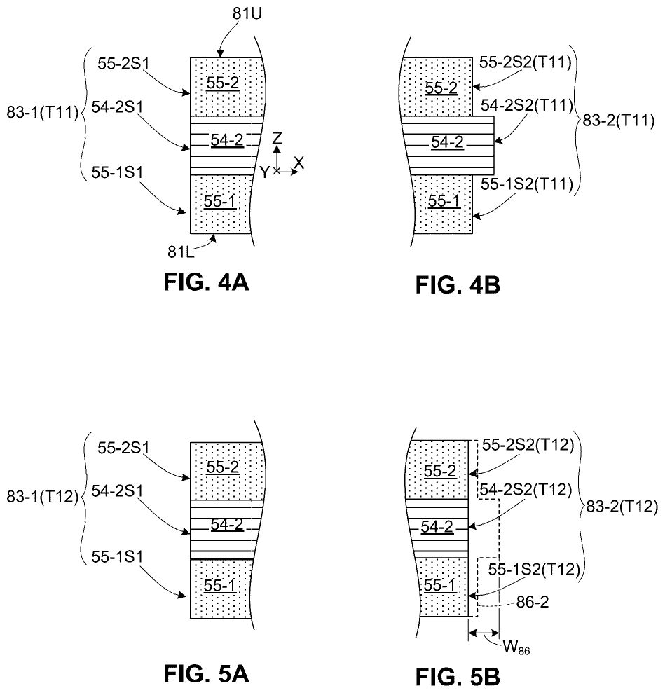

Referring to assembly 80(T11) in FIG. 3A, at time T11 assembly 80 includes an aligned panel side edge 83-1 and an opposing non-aligned panel side edge 83-2 and also includes an aligned panel end edge 82-1 and an opposing non-aligned panel end-edge 82-2. FIGS. 4A and 4B are cross-sections showing aligned panel side edge 83-1 and non-aligned panel side edge 83-2, respectively, at time T11 (i.e., before smoothing/processing has been performed). Specifically, FIG. 4A shows a cross section taken from a location along panel side edge 83-1 indicated by section line 4A-4A in FIG. 3A, and FIG. 4B shows a cross section taken from a location along panel side edge 83-2 indicated by section line 4B-4B in FIG. 3A (i.e., a portion of side edge 82-2 that has not been subjected to smoothing at time T11). As indicated in FIG. 4A, aligned panel side edge 83-1 is formed by veneer side edges 55-1S1, 54-2S1 and 55-2S1, which are planar and vertically aligned by way of the automated veneer stacking operation described above. In contrast, the veneer side edges forming non-aligned panel side edge 83-2 (i.e., side edges 55-1S2, 54-2S2 and 55-2S2) are typically vertically misaligned at time T11 (e.g., as indicated in FIG. 4B). The vertical misalignment depicted in FIG. 4B is an example of the misalignment that is typically generated by (i.e., is a byproduct of) the automated veneer stacking operation described above because the individual width dimensions of wood veneers 55-1, 55-2 and 54-2 typically vary (i.e., for reasons described in the background section, above). That is, when the width dimensions of successively stacked veneer layers are not equal and the successively stacked veneer layers are positioned to form vertically aligned side edge 83-1, this arrangement necessarily produces a vertical misalignment along opposing side edge 83-2. Similarly, because the length dimensions of veneers 55-1, 55-2, 54-1 and 54-2 also typically vary, by controlling the relative horizontal position between the successively stacked veneer layers such that selected (first) veneer end edges 55-1E1, 55-2E1 and 54-1E1 (shown in FIG. 1) are vertically aligned, any difference between the lengths of these veneers will necessarily produce a vertical misalignment at opposing (second) panel end edge 82-2. In effect, the automated veneer stacking operation described above localizes all edge misalignment to non-aligned panel side edge 83-2 and non-aligned panel end edge 82-2.

As also depicted in FIG. 3A, in one embodiment the smoothing/processing operation includes abrading non-aligned (opposing) panel side edge 83-2 (e.g., using a router 95 or other mechanism) until the individual veneer side edges forming panel side edge 83-2 are planarized (vertically aligned) and until a width of assembly 80 is equal to the specified target width of the finished plywood panel. As indicated in FIG. 5B, this smoothing/processing operation is performed to remove an amount of veneer (wood) material 86-2 (i.e., as indicated by dashed line regions in FIGS. 3A and 5B) from panel side edge 83-2 until side edge 55-1S2 of lowermost veneer 55-1, side edge 54-2S2 of intermediate veneer 55-2 (and the corresponding side edge 54-1S2 of intermediate veneer 55-1, shown in FIG. 1) and side edge 55-2S2 of uppermost veneer 55-2 are vertically aligned along the entire length of assembly 80(T12). That is, at time T12 (i.e., after smoothing processing is completed), the entirety of panel side edge 83-2 is planarized as shown in FIG. 5B. Moreover, as indicated in FIG. 3B, this smoothing/processing operation is performed until a width of assembly 80(T12), which is measured between selected panel side edge 83-1 and opposing panel side edge 83-2(T12), is reduced from initial width Wi at time T11 (shown in FIG. 3A) to targeted final width Wf of finished plywood panel PP at time T12 (e.g., four feet). Similarly, the smoothing/processing operation is performed to remove an amount of wood material from non-aligned panel end edge 82-2(T11) (e.g., as indicate by the dashed line region along panel end edge 82-2 in FIG. 3A) until veneer end edges 55-1E2, 54-2E2 and 55-2E2 are vertically aligned. Moreover, as indicated in FIG. 3B, the smoothing/processing of panel end edge 82-2 is performed until a length of assembly 80(T12), which is measured between selected panel end edge 82-1 and opposing panel end edge 82-2(T12), is reduced from initial length Li at time T11 (shown in FIG. 3A) to targeted final length Lf of finished plywood panel PP at time T12 (e.g., eight feet). Note that, as indicated by comparing FIGS. 4A and 5A, aligned panel side edge 83-1 is not subject to any significant smoothing/processing during the post-assembly operation, and therefore remains substantially unchanged between times T11 and T12. Similarly, aligned panel end edge 82-1 is not subject to any significant smoothing/processing during the post-assembly operation, and therefore remains substantially unchanged between times T11 and T12.

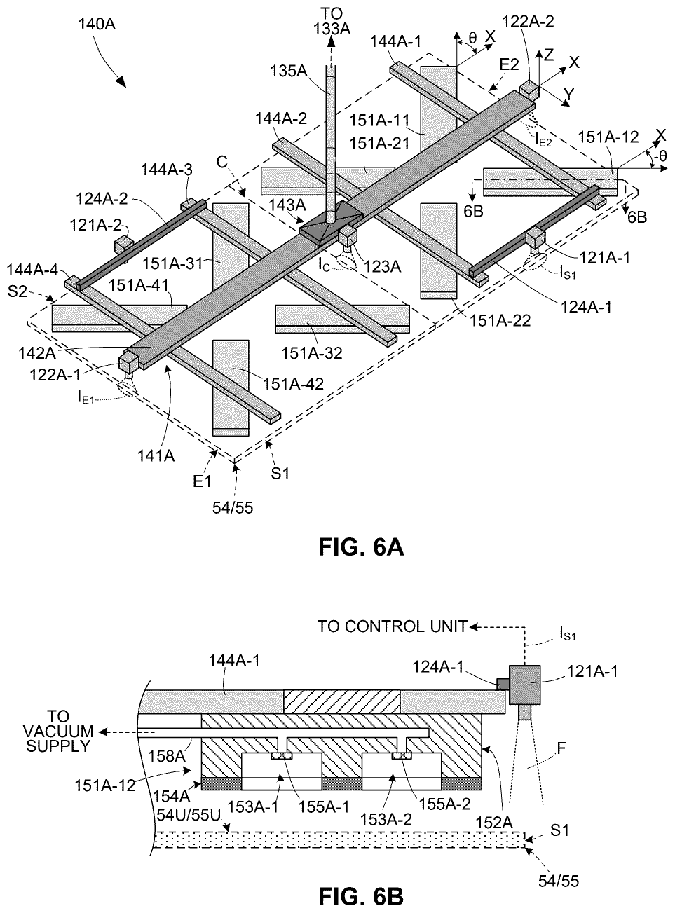

The generalized embodiments described above may be beneficially modified using the additional features and structures described below with reference to FIGS. 6A to 16C.

FIG. 6A shows a robotic end-tool 140A configured to move one full-size veneer or two half-size veneers during associated phases of the automated veneer stacking operation according to an exemplary practical embodiment. Robotic end-tool 140A includes a rigid frame 141A that is configured to be manipulated by articulated robot (as described below) and eight vacuum grippers 151A-11 to 151A-42 that are secured to frame 141A and arranged as described below to facilitate securing and moving one full-size or two half-size veneers from associated supply regions to an assembly region during the automated veneer stacking operation. Robotic end-tool 140A also includes multiple cameras 121A-1, 121A-2, 122A-1, 122A-2 and 123A that are respectively connected to frame 141A and positioned to generate image (sensor) data that may be used to determine locations of the selected side and end edges of the veneers. The following paragraphs provide additional details and features of the various components of robotic end-tool 140A.

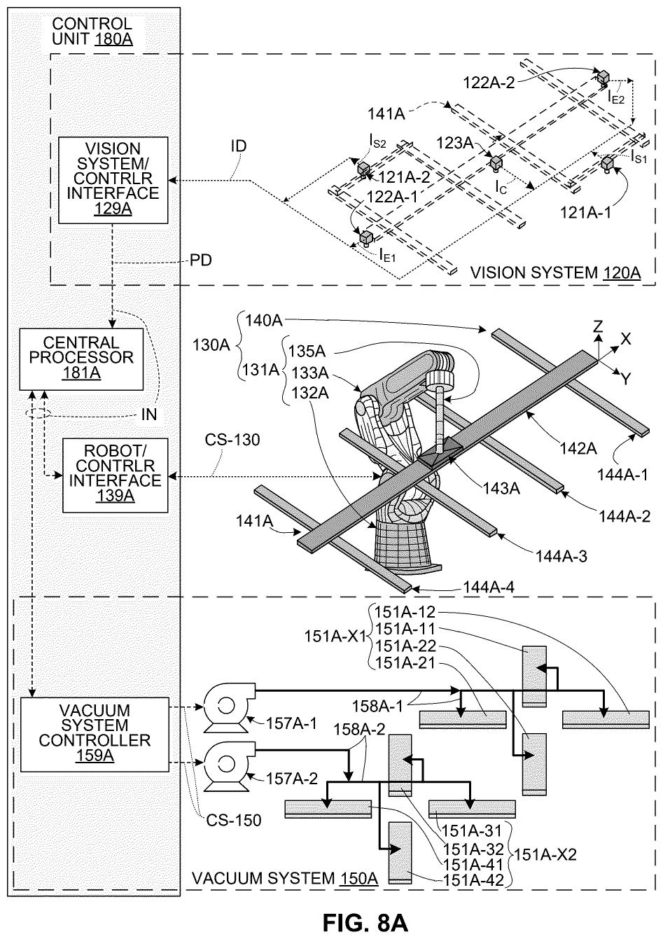

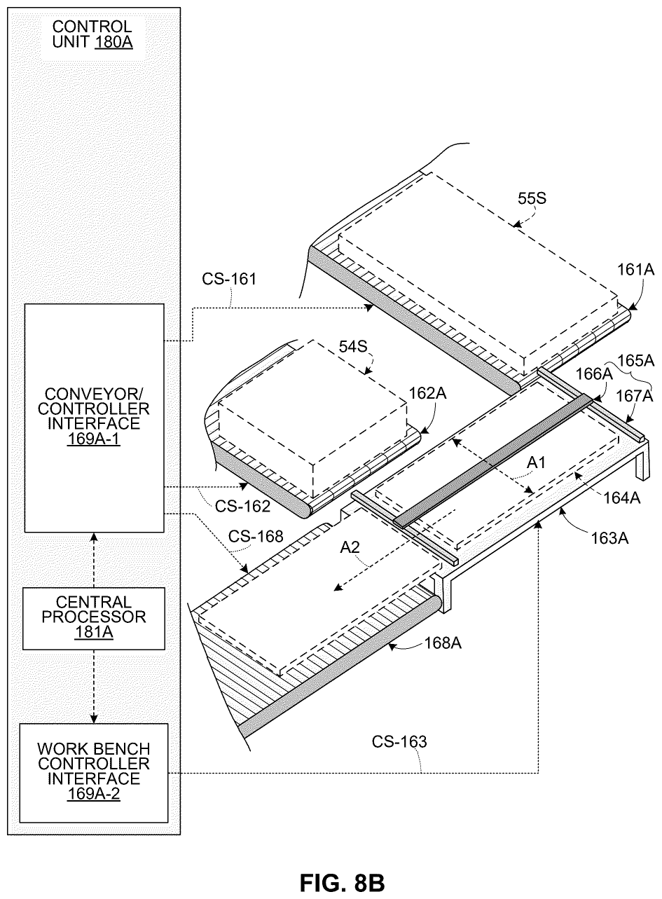

As indicated in FIG. 6A (and also in FIG. 8A), frame 141A includes an elongated spar 142A, a central hub fixture 143A and four ribs 144A-1 to 144A-4. Elongated spar 142A is a rigid beam that extends in a first horizontal direction (e.g., parallel to the X-axis direction indicated in FIG. 6A).

Central hub fixture 143A is fixedly connected to a central region of spar 142A and is configured for fixed connection to an end-shaft (distal end portion) 135A of an articulated robot (e.g., by way of inserting attaching end-shaft 135A inside a central opening of central hub fixture 143A and then utilizing a screw or other fastener to rigidly connect central hub fixture 143A to end-shaft 135A). Central hub fixture 143A is configured such that, when operably connected to end-shaft 135A, spar 142A is maintained in a horizontal direction (i.e., maintained in a horizontal plane that is perpendicular to the vertical/Z-axis direction) throughout the automated veneer stacking operations described herein. Ribs 144A-1 to 144A-4 are fixedly connected to elongated spar 142A and extend in parallel horizontal directions that are perpendicular to the orientation of elongated spar 142A. For example, spar 142A extends in the X-axis direction indicated in FIG. 6A, and ribs 144A-1 to 144A-4 extend parallel to the Y-axis direction.

Ribs 144A-1 to 144A-4 are connected to spar 142A such that, while spar 142A is maintained in a horizontal orientation, ribs 144A-1 to 144A-4 are also maintained in a horizontal plane. Finally, ribs 144A-1 to 144A-4 are substantially symmetrically arranged along spar 142A with ribs 144A-1 and 144A-2 located on one side of central hub fixture 143A and ribs 144A-3 and 144A-4 located on the opposing (second) side of central hub fixture 143A.

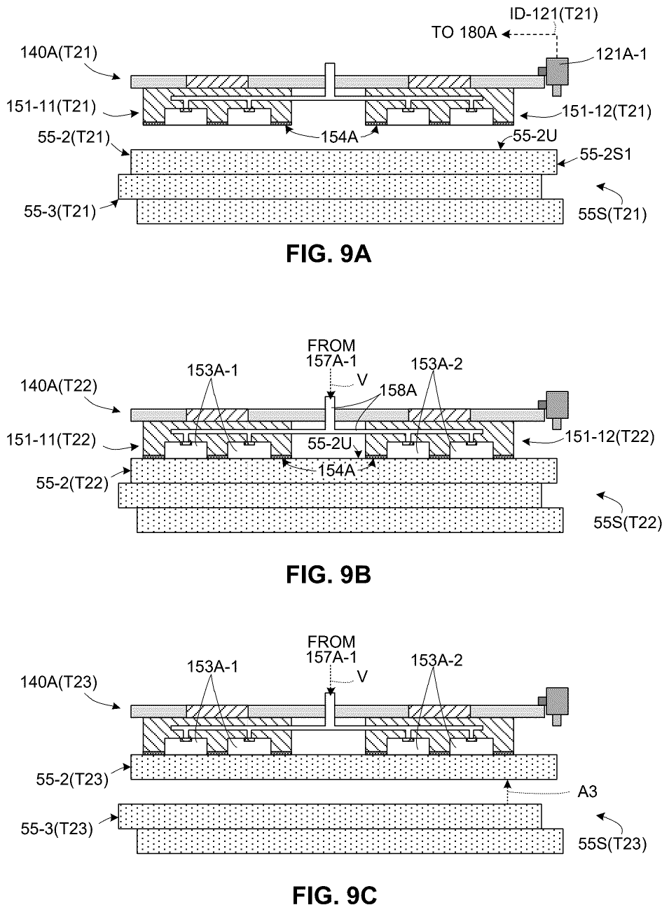

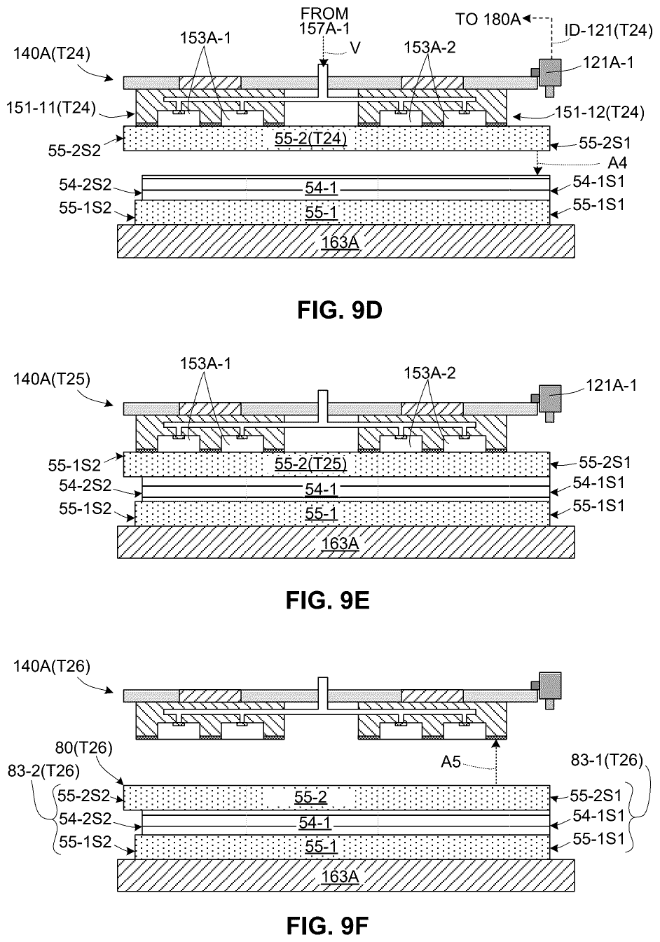

Vacuum grippers 151A-11 to 151A-42 are fixedly connected to frame 141A such that they are maintained in a horizontal plane below frame 141A during the automated veneer stacking operation. Each vacuum gripper has an elongated box-like housing that is fixedly connected to an associated rib and includes an array of downward-facing vacuum cavities that are operably coupled to a vacuum supply (not shown) to facilitate securing (attaching) a veneer to end-tool 140A during each phase of the automated veneer stacking operation. For example, as shown in FIG. 6B, vacuum gripper 151A-12 has an elongated housing 152A that is fixedly connected to a lower side of associated rib 144A-1 and includes downward-facing vacuum cavities 153A-1 and 153A-2 having lower openings surrounded by gasket seal 154A (e.g., a rubber or soft plastic sheet that otherwise covers the lower surface of housing 152A). Vacuum cavities 153A-1 and 153A-2 are respectively coupled to vacuum supply line 158A by way of associated isolation valves 155A-1 and 155A-2. As described below in additional detail with reference to FIGS. 9A to 9F, during each phase of the automated veneer stacking operation vacuum gripper 151A-12 is positioned over a veneer 54/55 and then lowered until gasket seal 154A contacts the veneer's upper surface 54U/55U, whereby housing 152A and the veneer form substantially airtight shells around vacuum cavities 153A-1 and 153A-2. Low pressure (vacuum) is then supplied to housing 152A by way of vacuum supply line 158A and isolation valves 155A-1 and 155A-2, whereby the resulting suction force generated in vacuum cavities 153A-1 and 153A-2 secures veneer 54/55 to vacuum gripper 151A-12. Isolation valves 155A-1 and 155A-2 are configured using known techniques to prevent unintentional release of veneer 54/55 by allowing vacuum cavities 153A-1 and 153A-2 to independently maintain low pressure. That is, if a localized flaw in upper veneer surface 54U/55U creates a leak through a portion of gasket seal 154A into cavity 153A-1, the resulting loss of vacuum is isolated in vacuum cavity 153A-1 by isolation valve 155A-1, whereby veneer 54/55 remains secured to vacuum gripper 151A-12 by way of the low pressure maintained in vacuum cavity 153A-2. Although described with reference to two vacuum cavities for clarity and brevity, vacuum gripper 151A-12 may include any number of vacuum cavities (e.g., arranged in an array of rows and columns). In an alternative embodiment (not shown), vacuum gripper 151A-12 may be implemented using an array of suction-cup-type vacuum cavities in place of the arrangement described with reference to FIG. 6B. Each of vacuum grippers 151A-11, 151A-21, 151A-22, 151A-31, 151A-32, 151A-41 and 151A-42 is configured and operates in the manner described above with reference to vacuum gripper 151-12.

Referring again to FIG. 6A, vacuum grippers 151A-11 to 151A-42 are arranged to form a pair of X-shaped patterns to facilitate maintaining veneers in a substantially horizontal plane below end-tool 140A during each phase of the automated veneer stacking operation. These X-shaped patterns are achieved by attaching two vacuum grippers to each rib 144A-1 to 144A-4 such that the elongated housings of each pair of vacuum grippers are aligned in opposing diagonal directions relative to the associated rib. For example, vacuum grippers 151A-11 and 151A-12 are attached to rib 144A-1, with the elongated housing of vacuum gripper 151A-11 aligned in a diagonal direction θ (e.g., 45°) relative to the X-axis and the elongated housing of vacuum gripper 151A-12 aligned in an opposing diagonal direction −θ relative to the X-axis.

Similarly, vacuum grippers 151A-21 and 151A-22 are attached to rib 144A-2, with the elongated housing of vacuum gripper 151A-21 aligned in diagonal direction −θ and the elongated housing of vacuum gripper 151A-22 aligned in opposing diagonal direction θ. Referring briefly to FIG. 8A, by way of this configuration vacuum grippers 151A-11, 151A-12, 151A-21 and 151A-22 collectively form a first X-shaped gripper group 151A-X1. Referring again to FIG. 6A, vacuum grippers 151A-31 and 151A-32 are attached to rib 144A-3 and vacuum grippers 151A-41 and 151A-42 are attached to rib 144A-4, where the housings of these four vacuum grippers are aligned in similar diagonal directions such that they collectively form a second X-shaped gripper group 151A-X2 (shown in FIG. 8A). Note that the four vacuum grippers of each X-shaped group 151A-X1 and 151A-X2 are configured to extend into a corresponding corner of two half-size veneers, thereby facilitating securing and maintaining two half-size veneers in a horizontal plane below end-tool 140A during each second assembly phase of the automated veneer stacking operation described herein. Similarly, vacuum grippers 151A-11, 151A-12, 151A-41 and 151A-42 respectively extend toward the four corners of a full-size veneer and vacuum grippers 151A-21 to 151A-32 are positioned over a central region of the full-size veneer, thereby facilitating securing and maintaining the full-size veneer in a horizontal plane below end-tool 140A during the first and third assembly phases of the automated veneer stacking operation described herein.

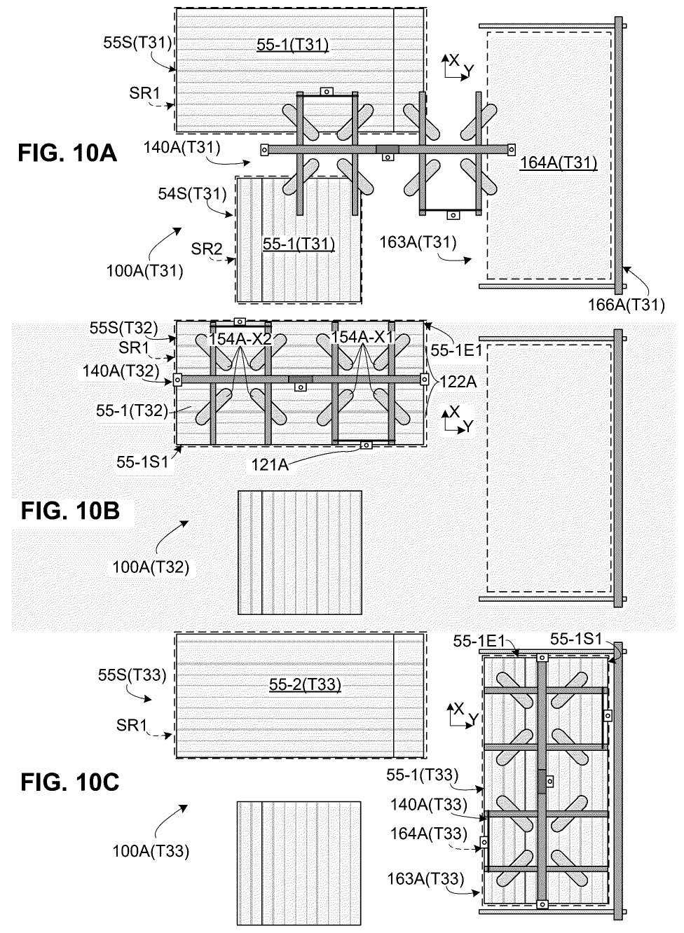

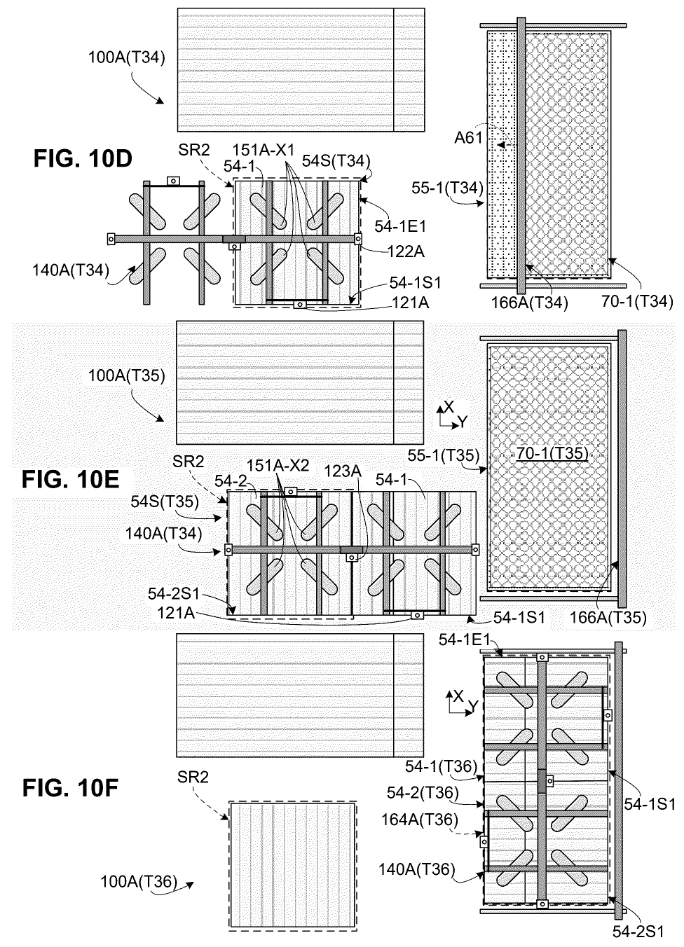

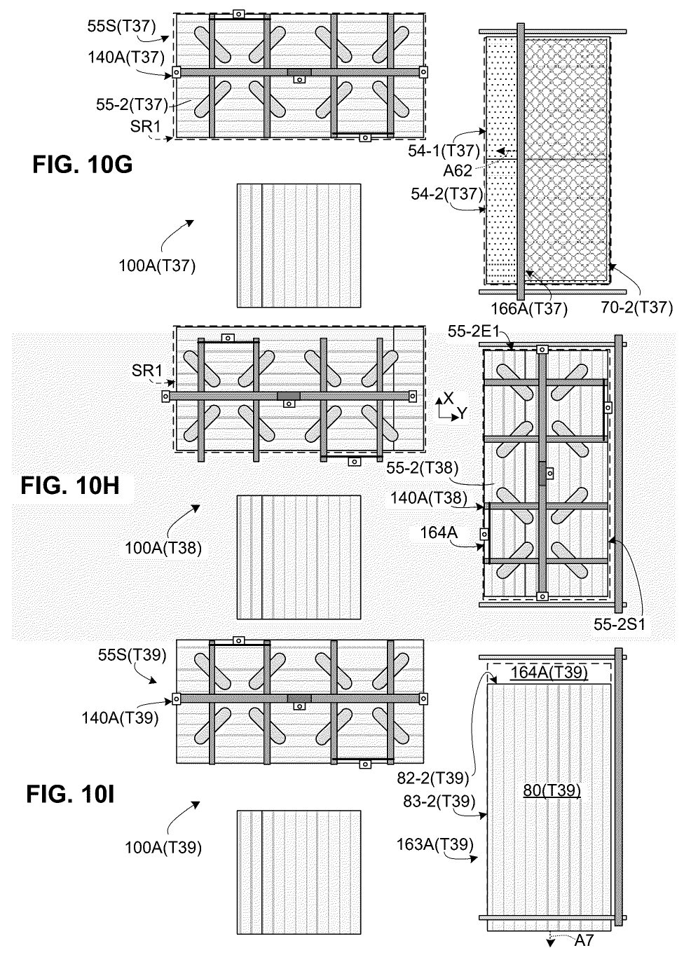

Referring again to FIG. 6A, cameras 121A-1 to 123A-2 form part of an image-based sensor system (image system 120A, described in additional detail below) and are configured to generate digital image (sensor) data that may be used to determine the locations of the selected veneer side and end edges, thereby facilitating alignment of the selected veneer side and end edges during the automated veneer stacking operation described herein. Camera 121A-1 is connected to frame 141A by way of a support rod (fixture) 124A-1 that extends between ribs 144A-1 and 144A-2 and is oriented (e.g., aimed vertically downward) such that it generates image data I_{S1} that captures selected side edge S1 of veneer 54/55. For example, as indicated in FIG. 6B, camera 121A-1 is secured to rib 144A-1 by way of support rod 124A-1 and oriented to capture/collect light from a field of view F such that camera 121A-1 generates image data I_{S1} that may be used to determine the location of side edge S1 of veneer 54/55. Image data I_{S1} is transmitted to a control unit (e.g., as described below with reference to FIG. 8A), which processes the image data using known techniques to determine the location of selected side edge S1. Similarly, cameras 121A-2 is connected to frame 141A by way of a support rod 124A-2 and is positioned and oriented to capture image data that is processed to determine the location of opposing side edge S2, cameras 122A-1 and 122A-2 are respectively mounted to opposing ends of spar 142A and oriented to image selected end edge E1 and opposing end edge E2 of veneer 54/55 and are configured to respectively generate image data I_{E1} and I_{E2} that is then processed using known techniques to determine the locations of end edges E1 and E2, and camera 123A is mounted to a central region of spar 142A and oriented to image centrally located edges C corresponding to half-size veneers (e.g., during the second assembly phase of some embodiments), and is configured to generate image data I_{C} that is then processed and utilized to facilitate the proper positioning of the two half-size veneers during the securing process in some embodiments (e.g., as described below with reference to FIGS. 10D and 10E).

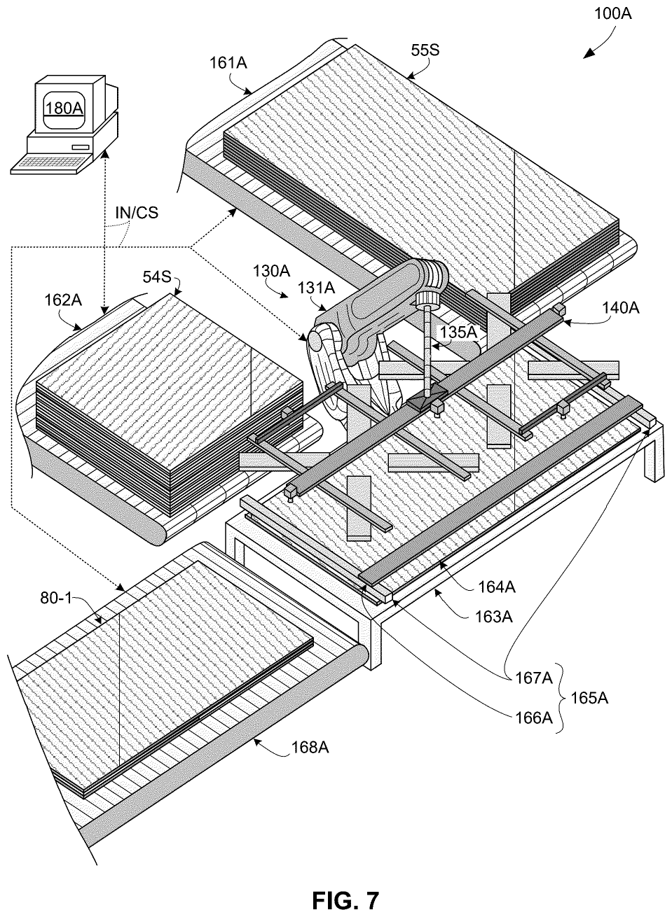

FIG. 7 depicts a plywood production work cell 100A for performing automated veneer stacking operations according to an exemplary practical embodiment. Work cell 100A generally includes a robot mechanism 130A, a full-size veneer supply conveyor 161A, a half-size supply conveyor 162A, a work bench (assembly structure) 163A, an assembly conveyor 168A and a control unit 180A according to an exemplary embodiment. Robot mechanism 130A includes a six-axis robot 131A and robotic end-tool 140A, which is connected to end shaft 135A of six-axis robot 131A. Robot 131A is described in additional detail below with reference to FIG. 8A, and end-tool 140A is described above with reference to FIGS. 6A and 6B and is described in additional detail below with reference to FIG. 8A. As also described below with reference to FIG. 8A, work cell 100A includes a vision system 120A that utilizes the various cameras mounted on end-tool 140A to facilitate the alignment of corresponding veneer side and end edges during each automated veneer stacking operation, and a vacuum system 150A that supplies low pressure to the vacuum grippers mounted on end-tool 140A to facilitate securing and moving veneers during each automated veneer stacking operation. Supply conveyor 161A is configured to convey full-size veneer supply stacks 55S into a first supply region accessible by robot mechanism 130A, and supply conveyor 162A is configured to convey half-size veneer supply stacks 54S into a second supply region accessible by robot mechanism 130A. Each supply stack 54S and 55S comprises multiple veneers arranged such that associated side/end edges of each veneer are generally vertically aligned. During the first and third assembly phases robot mechanism 130A is controlled to move an uppermost (top) full-size veneer from stack 55S to an assembly region 164A provided on work bench 163A. A glue applicator mechanism 165A is mounted on work bench 163A and includes an elongated glue dispenser 166A that is moved by way of guide rails 167A over assembly region 164A to apply glue for reasons described below. Work bench 163A also includes a mechanism (not shown) that is operably configured to transfer completed veneer assemblies onto assembly conveyor 168A. Assembly conveyor 168A is utilized to move the completed veneer assemblies (e.g., assembly 80-1) transferred from work bench 163A to a post-assembly processing location (not shown). Control unit 180A is a computer/processor that implements software-based instructions or is otherwise configured to execute a control algorithm that continuously monitors input data IN (e.g., image data generated by the cameras mounted on end-tool 140A, feedback data from robot 131A, and may include other control and/or sensor signals) and generates control signals CS that are utilized to coordinate the operations of work cell 100A in the manner described below.

FIGS. 8A and 8B are diagrams depicting additional details related to work cell 100A and also depict control and input data signal connections between control unit 180A and the various sub-systems of work cell 100A. FIG. 8A depicts additional details related to a vision (sensor) system 120A, robot mechanism 130A and vacuum system 150A, and shows exemplary control and input data signal connections IN between control unit 180A and robot mechanism 130A, vision (sensor) system 120A and vacuum system 150A. FIG. 8B shows additional details related to glue applicator mechanism 165A and shows exemplary control signal connections between control unit 180A and work structures including conveyors 161A, 162A, and 168A and work bench 163A.

Referring to the upper portion of FIG. 8A, vision system 120A is made up of side edge cameras 121A-1 and 121A-2, end edge cameras 122A-1 and 122A-2 and central camera 123A that are fixedly connected to frame 141A (e.g., as described above with reference to FIGS. 6A and 6B) and generate image data I_{S1}, I_{S2}, I_{E1}, I_{E2} and I_{C} (collectively referred to as image data ID) that is transmitted to control unit 180A by way of wired or wireless connection using known techniques. In some embodiments image data ID is preprocessed by a vision-system-to-controller interface 129A, and the preprocessed data PD is then passed to a central processor 181A of control unit 180A. In alternative embodiments interface 129A is either implemented as part of control unit 180A or implemented using a separate circuit. In some embodiments, image data ID may be transmitted directly to central processor 181A as part of input data IN.

Referring to the central portion of FIG. 8A, robot mechanism 130A includes six-axis robot 131A and robotic end-tool 140A. Robot 131A includes a base portion 132A, a multi-section arm portion 133A extending from base portion 132A, and end shaft 135A disposed at a free (distal) end of arm portion 133A. In an exemplary embodiment, six-axis robot 131A-1 is implemented using model R200iC/210L provided by Fanuc America Corporation of Rochester Hills, MI, USA. As described above with reference to FIGS. 6A and 6B, end-tool 140A includes a frame 141A made up of a longitudinal spar 142A that is connected to end shaft 135A by way of a central hub fixture 143A and four ribs 144A-1 to 144A-4 that extend perpendicular to spar 142A. Robot 131A is controlled by way of control signals CS-130 to move end-tool 140A between the supply and assembly regions in order to perform the automated veneer stacking operation described below with reference to FIGS. 10A to 10I. In some embodiments control signals CS-130 and other communications between central processor 181A and robot 131A are passed by way of a robot-to-controller interface 139A.

Referring to the lower portion of FIG. 8A, vacuum system 150A includes vacuum grippers 151A-11 to 151A-42, vacuum supplies/sources (e.g., pumps) 157A-1 and 157A-2, and vacuum supply lines 158A-1 and 158A-2. Vacuum grippers 151A-11 to 151A-42 are connected to ribs 144A-1 to 144A-4 and disposed in a horizontal plane below elongated spar 142A in the manner described above with reference to FIG. 4A, and each vacuum gripper is configured and operates in the manner described above with reference to FIG. 4B. Each of vacuum grippers 151A-11, 151A-12, 151A-21 and 151A-22, which collectively form first X-shaped group 151A-X1, is coupled to vacuum supply 156A-1 by way of associated vacuum supply line 158A-1. Similarly, vacuum grippers 151A-31, 151A-32, 151A-41 and 151A-42, which collectively form second X-shaped group 151A-X2, are coupled to vacuum supply 156A-2 by way of associated vacuum supply line 158A-2. In some embodiments control signals CS-150, which actuate vacuum supplies 157A-1 and 157A-2, are transmitted from central processor 181A by way of a vacuum-system-to-controller interface 159A. In some embodiments, confirmation and other feedback signals are transmitted from vacuum system controller 159A to central processor 181A as part of input signals IN.

FIG. 8B shows additional control signal connects between control unit 180A and the various work structures of work cell 100A according to an exemplary embodiment. Full-size veneer supply conveyor 161A is configured to maintain a first supply stack 55S of full-size veneers in a suitable supply region during the automated veneer stacking operation described below and is controlled by way of a control signal CS-161 to move a second stack of full-size veneers (not shown) into the supply region after all of the veneers in the first have been moved to the assembly region. Similarly, half-size veneer supply conveyor 162A is controlled by way of a control signal CS-162 to move supply stacks 54S of half-size veneers into a corresponding supply region. Glue applicator mechanism 165A is actuated by way of a work bench control signal CS-163 such that glue dispenser 166A travels along guide rails 167A to pass over assembly region 164A (e.g., as indicated by arrow A1). Work bench control signal CS-163 may also control an automated mechanism (not shown) that is configured to move completed veneer assemblies out of assembly region 164A and off of work bench 163A onto assembly conveyor 168B (e.g., as indicated by dashed-line-arrow A2). Assembly conveyor 168B is controlled by way of a control signal CS-168 to move completed veneer assemblies to a post-assembly processing area (not shown). In some embodiments control signals CS-161, CS-162 and CS-168, which actuate supply conveyors 161A, 162A and 168A, are transmitted from central processor 181A by way of a conveyor-to-controller interface 169A-1, and work bench control signal(s) CS-163 are transmitted from central processor 181A by way of a work-bench-to-controller interface 169A-2.

FIGS. 9A to 9F are simplified cross-sectional side views depicting operations performed by vacuum grippers 151A-11 and 151A-12 (i.e., two of the eight vacuum grippers mounted on end-tool 140A) and camera 121A-1 (i.e., the camera utilized to determine the location of a selected veneer side edge 55-2S1) during an exemplary third assembly phase involving the movement and placement (stacking) of an exemplary uppermost veneer 55-2. As indicated in FIGS. 9A to 9F, end-tool 140A is configured to maintain uppermost veneer 55-2 in a substantially horizontal orientation throughout the moving and placing operations. Note this example assumes first and second assembly phases have already been performed (i.e., as indicated in FIGS. 9C to 9F, lowermost veneer 55-1 and intermediate veneers 54-1 and 54-2 have already been moved/placed on work bench 163A). Note also that operations performed by vacuum grippers 151A-11 and 151A-12 and camera 121A-1 during the first and second assembly phases are understood as involving substantially the same operations described with reference to the exemplary third assembly phase, and that operations performed by the other vacuum grippers and cameras (not shown in FIGS. 9A-9F) that are mounted on end-tool 140A are similar to those described with reference to FIGS. 9A to 9F.

FIGS. 9A to 9C depict utilizing vacuum grippers 151A-11 and 151A-12 of robotic end-tool 140A to secure and lift uppermost (second outer) veneer 55-2 from a veneer supply stack 55S, which is located in a designated supply region (e.g., supply conveyor 161A, as shown in FIG. 7). FIG. 9A shows end-tool 140A at a time T21 when the associated robot mechanism (e.g., robot mechanism 130A, shown in FIG. 7) is controlled (e.g., by controller 180A, shown in FIG. 7) to position end-tool 140A over full-size veneer supply stack 55S (i.e., such that gasket seals 154A of both vacuum grippers 151A-11 and 151A-12 are separated from upper surface 55-2U of uppermost veneer 55-2). Note that, at time T21, supply stack 55S includes uppermost veneer 55-2 stacked on top of a next-sequential full-size veneer 55-3, and that the relative position of side and end edges of the veneers forming supply stack 55S may be misaligned. In some embodiments image data ID-121(T21) generated by camera 121A-1 is utilized to control the robot such that end-tool 140A is positioned in an optimal location to secure uppermost veneer 55-2 (e.g., such that camera 121A-1 is positioned directly over selected side edge 55-2S1). Vacuum supply 157A-1 (shown in FIG. 8A) may be turned off at time T21. FIG. 9B shows end-tool 140A at a subsequent time T22 when the robot is controlled to move end-tool 140A toward supply stack 55S such that gasket seals 154A of vacuum grippers 151A-11 and 151A-12 contact upper surface 55-2U of uppermost veneer 55-2, and after a vacuum (low) pressure V is transmitted from vacuum supply 157A-1 (shown in FIG. 8A) to vacuum cavities 153A-1 and 153A-2 by way of vacuum supply lines 158A, thereby securing uppermost veneer 55-2 to end-tool 140A. FIG. 9C shows end-tool 140A at a subsequent time T23 when the robot is controlled to lift end-tool 140A upward from supply stack 55S while vacuum supply 157A-1 (see FIG. 8A) maintains vacuum (low) pressure V in vacuum cavities 153A-1 and 153A-2, whereby uppermost veneer 55-2 is lifted off of next sequential veneer 55-3 (as indicated by arrow A3).

FIGS. 9D to 9F depict a second part of the third assembly phase in which the associated robot mechanism (e.g., robot mechanism 130A, shown in FIG. 7) controls and positions end-tool 140A during the placement (positioning and then release) of uppermost veneer 55-2. FIG. 9D shows end-tool 140A at a time T24 after the robot mechanism has been controlled (e.g., by controller 180A, shown in FIG. 7) to move end-tool 140A from the first supply region to a position over the assembly region (e.g., upper surface) of work bench 163A. Note that lowermost veneer 55-1 and intermediate veneers 54-1 and 54-2 were previously placed on work bench 163A during first and second assembly phases, respectively, and that intermediate veneer 54-2 is obscured by (located behind) intermediate veneer 54-1 in FIGS. 9D to 9F. Note also that side edge 54-1S1 (and a corresponding side edge of intermediate veneer 54-2) was vertically aligned with selected side edge 55-1S1 of lowermost veneer 55-1 during the second assembly phase. At time T24, vacuum supply 157A-1 (not shown) remains actuated to maintain vacuum (low) pressure V in vacuum cavities 153A-1 and 153A-2, whereby uppermost veneer 55-2 remains secured to end-tool 140A. Image data ID-121 generated by camera 121A-1 at time T24 is utilized to control the robot mechanism such that end-tool 140A(T24) is precisely positioned over intermediate veneers 54-1 and 54-2 (i.e., such that selected side edge 55-2S1 of uppermost veneer 55-2 is vertically aligned with selected side edge 54-1S1 of intermediate veneer 54-1 and selected side edge 55-1S1 of lowermost veneer 55-1). Referring briefly to FIG. 7, controller 180A also controls robot 131A (i.e., in response to image data from one or more other cameras mounted on end-tool 140A) to position a selected end edge of uppermost veneer 55-2 over corresponding end edges of intermediate veneer 54-1 and lowermost veneer 55-1 at time T24. Referring again to FIG. 9D, when uppermost veneer 55-2 is positioned, the robot causes end-tool 140A to lower uppermost veneer 55-2 toward work bench 163A (as indicated by arrow A4). FIG. 9E shows end-tool 140A at a subsequent time T25 after the robot mechanism has been controlled (e.g., by controller 180A, shown in FIG. 7) to place uppermost veneer 55-2 on intermediate veneer 54-1, whereby the image data from camera 121A-1 is utilized to vertically align side edge 55-2S1 of uppermost veneer 55-2 with side edge 54-1S1 of intermediate veneer 54-1 and side edge 55-1S1 of lowermost veneer 55-1. After placement is completed, the vacuum supply is deactivated (e.g., the pressure in vacuum cavities 153A-1 and 153A-2 is allowed to normalize to atmospheric pressure), whereby uppermost veneer 55-2 is released from end-tool 140A. As indicated in FIG. 9F, at a subsequent time T26 the robot moves end-tool 140A upward from work bench 163A (as indicated by arrow A5), thus completing the assembly process. Note that, at time T26 (i.e., immediately after completion of the assembly process), assembly 80(T26) includes an aligned panel side 83-1(T26), which is made up of vertically aligned veneer side edges 55-1S1, 54-1S1 and 55-2S1 of veneers 55-1, 54-1 and 55-2, and an opposing non-aligned side edge 83-2(T26), which is made up of opposing veneer side edges 55-1S2, 54-1S2 and 55-2S2.

FIGS. 10A to 10I are simplified top views showing work cell 100A during an exemplary automated veneer stacking operation. Various structures of work cell 100A (e.g., robot 131A, supply conveyors 161A and 162A and assembly conveyor 168A, all of which are shown in FIG. 7) are omitted from FIGS. 10A to 10I for clarity and brevity.

FIG. 10A depicts an exemplary initial state of work cell 100A at a time T31 immediately before beginning the exemplary automated veneer stacking operation. End-tool 140A, which is shown in an arbitrary location at time T31, is secured to and moved by an associated robot (e.g., robot 131A by way of distal end portion 135A, shown in FIG. 7) into each of the positions indicated in FIGS. 10B to 10I. A full-size veneer supply stack 55S is moved into an appropriate supply region SR1 by supply conveyor 161A (shown in FIG. 7). At time T31, veneer 55-1 is the top (uppermost) veneer of supply stack 55S at time T31. Similarly, a half-size veneer supply stack 54S is moved into an appropriate supply region SR2 by an associated supply conveyor (e.g., conveyor 162A, shown in FIG. 7), and veneer 54-1 is the top veneer of supply stack 54S at time T31. Work bench 163A is configured to provide assembly region 164A, which is empty (clear) at time T31, and the glue applicator mechanism is in a stand-by operating state (i.e., such that glue dispenser 166A is positioned away from assembly region 164A).

FIGS. 10B and 10C show work cell 100A at times T32 and T33, respectively, during the first assembly phase of the exemplary automated veneer stacking operation. Referring to FIG. 10B, the robot position end-tool 140A over supply region SR1, then lowers end-tool 140A onto top veneer 55-1 of supply stack 55S, and then the vacuum system is actuated such that the vacuum grippers of both X-shaped groups 151A-X1 and 151A-X2 secure veneer 55-1 to end-tool 140A. Image data from side cameras 121A and end cameras 122A may be used to position end-tool 140A during the securing operation (i.e., such that side cameras 121A are located directly over side edge 55-1S1 and end cameras 122A are located directly over end edge 55-1E1). Note that the elongated housing of each vacuum gripper is oriented diagonal to the grain of veneer 55-1 (which extends in the Y-axis direction in FIG. 10B), and that the vacuum grippers of both X-shaped groups 151A-X1 and 151A-X2 collectively secure a significant surface area of veneer 55-1 to maintain veneer 55-1 in a substantially horizontal orientation during subsequent movement to the assembly region. FIG. 10C shows work cell 100A at time T33 after the robot has moved veneer 55-1 from supply area SR1 to work bench 163A and placed veneer 55-1 in assembly region 164A (e.g., using securing, moving and releasing operations similar to those described above with reference to FIGS. 9A to 9F). Removing veneer 55-1 from supply stack 55S uncovers veneer 55-2 (i.e., such that veneer 55-2 becomes the topmost veneer of supply stack 55S at time T33). Note that end-tool 140A is rotated clockwise 90° by the robot while moving veneer 55-1 from supply region SR1 to assembly region 164A, whereby veneer 55-1 is placed in designated assembly region 164A such that the grain of veneer 55-1 is aligned in the X-axis direction at time T33. Note also that the image data captured during the movement and/or placing of veneer 55-1 may be used to record the locations of selected side edge 55-1S1 and selected end edge 55-1E1 (e.g., for reference during subsequent assembly phases).

FIGS. 10D, 10E and 10F show work cell 100A at times T34, T35 and T36, respectively, during a second assembly phase of the exemplary automated veneer stacking operation. In the depicted embodiment two intermediate veneers are secured and moved from a single supply location (i.e., both are removed from supply stack 54S) during the second assembly phase. In other embodiments, other operations may be implemented, such as procuring the two intermediate veneers from two separate stacks, and/or by utilizing separate moving and placing operations for each intermediate veneer.

FIG. 10D depicts work cell 100A at time T34 while the robot controls end-tool 140A to remove a first intermediate veneer 54-1 from veneer supply stack 54S using the four vacuum grippers forming X-shaped group 151A-X1 (i.e., using a first portion of end-tool 140A). The robot positions the first portion of end-tool 140A over supply region SR2, then lowers end-tool 140A onto top veneer 54-1 of supply stack 54S, and then at least a portion of the vacuum system is actuated such that the vacuum grippers of X-shaped group 151A-X1 secures veneer 54-1 (i.e., the top veneer of supply stack 54S at time T34) to end-tool 140A. Image data from two of the four side cameras 121A and end cameras 122A may be used to position end-tool 140A during this securing operation. Referring to the right side of FIG. 10D, while the robot controls end-tool 140A to secure intermediate veneer 54-1, the glue applicator mechanism is actuated to apply a first glue layer 70-1 onto an upward-facing surface of lowermost veneer 55-1. For example, elongated glue dispenser 166A is caused to move over veneer 54-1 (e.g., in the direction indicated by arrow A61) while applying (e.g., spraying or otherwise dispensing) glue in a manner that generates a suitable glue layer 70-1 on veneer 55-1. Note that this glue application operation is performed before the robot mechanism places the two intermediate veneers 54-1 and 54-2 on lowermost veneer 55-1 (as described below with reference to FIG. 10F).

FIG. 10E depicts work cell 100A at time T35 while the robot controls end-tool 140A to remove a second intermediate veneer 54-2 from veneer supply stack 54S using the four vacuum grippers forming X-shaped group 151A-X2 (i.e., using a second portion of end-tool 140A). Note that removing veneer 54-1 from stack 54S uncovers veneer 54-2, whereby veneer 54-2 becomes the top veneer of supply stack 54S at time T35. The robot positions the second portion of end-tool 140A over supply region SR2, then lowers end-tool 140A onto top veneer 55-2, and then at least a portion of the vacuum system is actuated such that the vacuum grippers of X-shaped group 151A-X2 secures veneer 54-2 to end-tool 140A. Image data from the other two side cameras 121A and center cameras 123A may be used to position end-tool 140A during this securing operation such that a minimal or zero gap exists between intermediate veneers 54-1 and 54-2 when both are secured by end-tool 140A.

FIG. 10F depicts work cell 100A at time T36 after the robot controls end-tool 140A to simultaneously move intermediate veneers 54-1 and 54-2 from supply region SR2 to designated assembly region 164A and to place intermediate veneers 54-1 and 54-2 on the lowermost (first outer) veneer and intervening glue layer (i.e., lowermost veneer 55-1 and glue layer 70-1, both shown in FIG. 10E). Image (sensor) data that generated during the placement process and/or is stored in memory is utilized to horizontally position intermediate veneers 54-1 and 54-2 relative to lowermost veneer such that side edges 54-1S1 and 54-2S1 are vertically aligned with the corresponding side edge of the lowermost veneer and such that selected end edge 54-2E1 of intermediate veneer 54-2 is vertically aligned with an associated end edge of the lowermost veneer. Note that end-tool 140A is rotated clockwise 90° by the robot while moving intermediate veneers 54-1 and 54-2 from supply region SR2 to assembly region 164A, whereby intermediate veneers 54-1 and 54-2 are placed in designated assembly region 164A such that their grain direction is aligned in the Y-axis direction at time T36 (i.e., the grains of both intermediate veneers 54-1 and 54-2 are aligned perpendicular to grain direction of the lowermost veneer).

FIGS. 10G and 10H show work cell 100A during a third assembly phase of the exemplary automated veneer stacking operation in which an uppermost (second outer) veneer is stacked on the partially formed veneer assembly, and FIG. 10I depicts work cell 100A after completion of the third assembly phase.

FIG. 10G shows work cell 100A at time T37 after the robot has moved end-tool 140A back from assembly region 164A to supply region SR1, then lowered end-tool 140A onto veneer 55-2, which is the top veneer of supply stack 55S(T37), and then actuated the vacuum system such that the vacuum grippers have secured veneer 55-2(T37) to end-tool 140A (e.g., as described above with reference to FIGS. 9A to 9C). Referring to the right side of FIG. 10G, while the robot controls end-tool 140A to secure veneer 55-2, the glue applicator mechanism is actuated (e.g., elongated glue dispenser 166A is caused to move in the direction indicated by arrow A62) to apply a second glue layer 70-2(T37) onto upward-facing surfaces of intermediate veneers 54-1 and 54-2. Note that this glue application operation is performed before the robot mechanism places uppermost (second outer) veneer 55-2 onto intermediate veneers 54-1(T37) and 54-2(T37), as described below with reference to FIG. 10H.

FIG. 10H depicts work cell 100A at time T38 after the robot controls end-tool 140A to move uppermost veneer 55-2(T38) from supply region SR1 to designated assembly region 164A and to place veneer 55-2 on the intermediate veneers and the intervening glue layer (i.e., intermediate veneers 54-1 and 54-2 and intervening glue layer 70-2, which are shown in FIG. 10G). Image (sensor) data that is generated during this placement process and/or is stored in memory is utilized to horizontally position uppermost veneer 55-2 relative to intermediate veneers 54-1 and 54-2 such that side edge 55-2S1 is vertically aligned with the corresponding side edges of both the underlying intermediate veneers and the lowermost veneer (e.g., as described above with reference to FIGS. 9D to 9F), and such that end edge 55-2E1 of uppermost veneer 55-1 is vertically aligned with associated end edges of the underlying intermediate veneer and the lowermost veneer. Note that the grain direction of uppermost veneer 55-2(T38) is aligned in the X-axis direction when placed (stacked) onto the intermediate veneers such that it is aligned parallel to the grain direction of the lowermost veneer and perpendicular to the grain directions of the two intermediate veneers.

FIG. 10I depicts work cell 100A at a subsequent time T39, which corresponds to a final stage of the automated veneer stacking operation described above with reference to FIGS. 10A to 10H, and the beginning of a subsequent automated veneer stacking operation. Referring to work bench 163A, at time T39 assembly 80 is automatically moved (e.g., pushed other otherwise propelled out of assembly region 164A, as indicated by dashed-line-arrow A7) by way of an automated mechanism (not shown) onto an assembly conveyor (e.g., conveyor 168A, shown in FIG. 7) for transfer to a post-assembly processing area (not shown), where non-aligned end edge 82-2 and non-aligned side edge 83-2 are smoothed/processed and assembly 80 is otherwise processed into a completed plywood panel (e.g., panel PP shown in FIG. 3B) that is ready for sale or use. Once assembly 80(T39) has been entirely removed from work bench 163A, assembly region 164A is made available to receive veneers associated with the subsequent automated veneer stacking operation. Referring to the upper left portion of FIG. 10I, in one embodiment the articulated robot (not shown) positions end-tool 140A(T39) over full-size veneer stack 55S(T39) while assembly 80(T39) is being removed from assembly region 164A, thereby further increase production efficiency by overlapping a portion of the first assembly phase of the subsequent automated veneer stacking operation with the final phase of the previous automated veneer stacking operation.

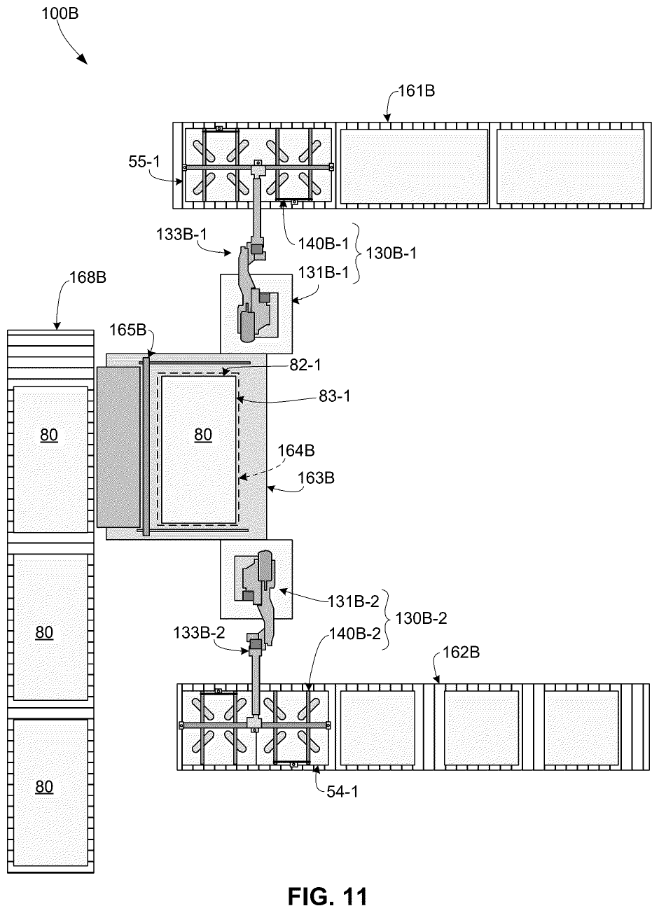

FIG. 11 shows a plywood assembly work cell 100B according to another exemplary embodiment in which two robot mechanisms 130B-1 and 130B-2 are utilized to perform an automated veneer stacking operation similar to that described above. Work cell 100B includes a full-size veneer supply conveyor 161B, a half-veneer supply conveyor 162B, a work bench (assembly structure) 163B and an assembly conveyor 168B that are configured and function in a manner similar to that described above with reference to work cell 100A. Robot mechanism 130B-1 is positioned and configured to move full-size veneers from full-size veneer supply conveyor (first supply region) 161B to a designated assembly region/surface (work area) 164B provided on work bench 163B during first and third assembly operations, and robot mechanism 130B-2 is positioned and configured to move half-size veneers from half-size veneer supply conveyor (second supply region) 162B to work area 164B during second assembly operations. Robot mechanisms 130B-1 and 130B-2 respectively include an associated end-tool 140B-1 and 140B-2 that are connected to distal end portions of multi-section arm portions 133B-1 and 133B-2 of corresponding six-axis robots 131B-1 and 131B-2. A control unit (not shown) coordinates operations of robot mechanisms 130B-1 and 130B-2 during each automated veneer stacking operation such that (first) robot mechanism 130B-1 moves a lowermost veneer from a first supply region (e.g., from a supply stack 55S-1 provided on supply conveyor 161B) to designated work area 164B during a first assembly phase, (second) robot mechanism 130B-2 moves a pair of intermediate veneers from a second supply region (e.g., from supply stack 54S provided on supply conveyor 162B) to designated work area 164B during a second assembly phase, and then robot mechanism 130B-1 moves an uppermost veneer from the first supply region to designated work area 164B during a third assembly phase. Robot mechanisms 130B-1 and 130B-2 are otherwise configured and operate in the manner described above with reference to robot mechanism 130A. Image data generated by the cameras mounted on end-tools 140B-1 and 140B-2 is utilized by the control unit to coordinate the operations of control robot mechanisms 130B-1 and 130B-2 such that selected side and end edges of the stacked veneers provide each assembly 80 with an aligned end edge 82-1 and an aligned side edge 83-1 having the characteristics described above. Note that this arrangement allows robot mechanism 130B-2 to secure and move the two intermediate half-size veneers while robot mechanism 130B-1 places the lowermost full-size veneer, and allows robot mechanism 130B-1 to secure and move uppermost full-size veneer while robot mechanism 130B-1 places the intermediate half-size veneers, thereby significantly reducing the total time required to perform each automated veneer stacking operation. A glue applicator mechanism 165B provided on work bench 163B operates in a manner similar to that described above to apply glue onto the lowermost and intermediate veneer layers after the first and second assembly phases, respectively. Completed veneer assemblies 80 are then moved by way of an automated mechanism (not shown) onto conveyor 168B for transfer to a post-assembly processing area (not shown).

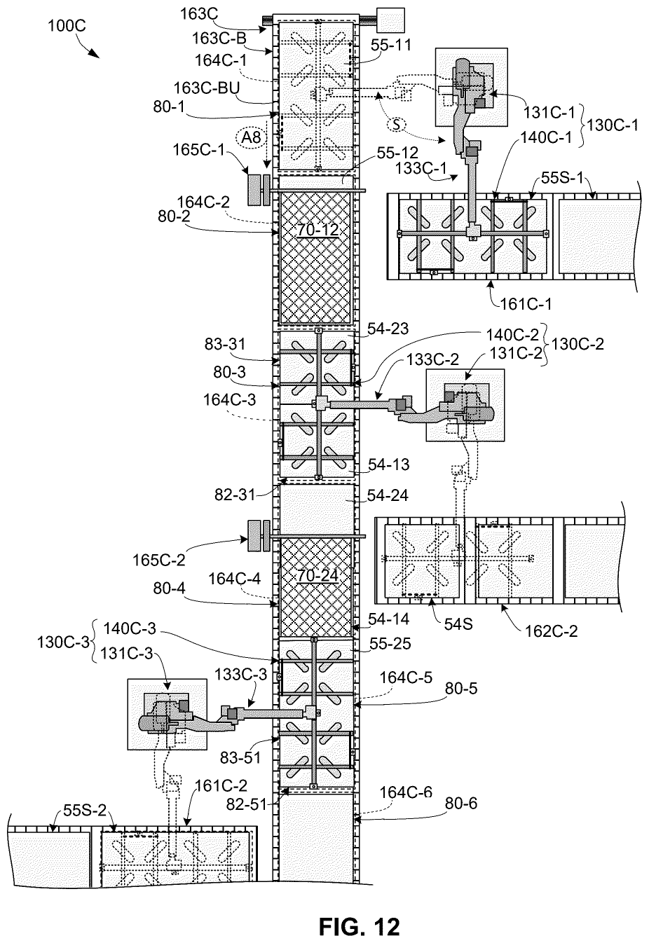

FIG. 12 shows a plywood production work cell 100C according to another exemplary embodiment in which the automated veneer stacking method of the present invention is utilized to produce three-layer plywood panel assemblies in an automated assembly-line manner. That is, instead of producing plywood panel assemblies one at a time in a stationary assembly region, plywood production work cell 100C utilizes a conveyor-type assembly structure 163C to simultaneously produce multiple plywood panel assemblies using a series of assembly stages. In the exemplary embodiment, plywood production work cell 100C utilizes three robot mechanisms 130C-1, 130C-2 and 130C-3 and two glue applicator mechanisms 165C-1 and 165C-2 that are positioned along a conveyor-type assembly structure 163C and coordinated by a control unit (not shown) to perform automated veneer stacking operations in an automated assembly-line manner. Conveyor-type assembly structure 163C includes a continuous conveyor belt 163C-B that is trained between at least two roller mechanisms such that the belt's upper surface 163C-BU is maintained in a substantially horizontal plane and provides six sequentially aligned work areas (assembly regions) 164C-1 to 164C-6. The control unit (not shown) coordinates operations such that, as the belt's upper surface 163C-BU is driven to move intermittently or continuously in the direction of arrow A8 (i.e., downward in FIG. 12). Similar to previous embodiments, each robot mechanism 130C-1, 130C-2 and 130C-3 includes an associated end-tool 140C-1, 140C-2 and 140C-3 that are respectively connected to distal end portions of multi-section arm portions 133C-1, 133C-2 and 133C-3 of corresponding six-axis robots 131C-1, 131C-2 and 131C-3. Robot mechanisms 130C-1, 130C-2 and 130C-2 are otherwise configured and operate in the manner described above with reference to work cells 100A and 100B. For example, image data generated by cameras mounted on end-tool 140C-2 is utilized by the work cell's control unit to coordinate operations of second robotic mechanism 130C-2 in a manner similar to that described above with reference to FIG. 11 (i.e., such that the veneer side edges of each pair of intermediate veneers are precisely aligned with the veneer side edge of an associated underlying lowermost veneer, as indicated by panel side edge 83-31, and such that the veneer end edge of one of the two intermediate veneers is precisely aligned with the selected veneer end edge of the underlying lowermost veneer, as indicated by panel end edge 82-31). Glue applicator mechanisms 165C-1 and 165C-2 are positioned along conveyor belt 163C-B and controlled by the control unit (not shown) to apply glue layers onto the lowermost and intermediate veneer layers, respectively, in a manner similar to that described above with reference to work cells 100A and 100B. Due to the conveyor-type arrangement of plywood production work cell 100C, each glue applicator mechanism 165C-1 and 165C-2 may include a stationary glue dispenser that is operably arranged and positioned over conveyor belt 163C-B to apply glue onto each plywood panel assembly as it is moved (conveyed) under the stationary glue dispenser by conveyor belt 163C-B.

FIG. 12 depicts plywood production work cell 100C at a point in time during which six plywood panel assemblies 80-1 to 80-6 are at sequential stages of the assembly-line-type assembly process. Referring to the upper portion of FIG. 12, a first plywood panel assembly 80-1 is at a first (initial) assembly stage during which an associated lowermost outer veneer 55-11 has been deposited onto assembly region 164C-1 by first robot mechanism 130C-1 (e.g., by controlling robot mechanism 130C-1 to move veneer 55-11 from supply stacks 55S-1 provided on supply conveyor 161C-1 to designated work area 164C-1 by way or rotating arm portion 131C-1 along the path indicated by dashed-double-arrow S). A second panel assembly 80-2, which includes an associated second lowermost outer veneer 55-12 that was previously deposited onto an assembly region 164C-2, is positioned at the second assembly stage at which a glue layer 70-12 is applied onto lowermost outer veneer 55-12 as conveyor belt 163C-B moves assembly 80-2 under first glue applicator mechanism 165C-1. A third panel assembly 80-3 is disposed on an assembly region 164C-3 and positioned at a third assembly stage at which a pair of intermediate veneers 54-13 and 54-23 are mounted onto an underlying associated lowermost outer veneer and first glue layer (both being obscured by intermediate veneers 54-13 and 54-23). Intermediate veneers 54-13 and 54-23 are moved by second robot mechanism 130C-2 and end tool 140C-2 from a second supply region (e.g., from a veneer supply stack 54S provided on a second supply conveyor 162C-2). A fourth panel assembly 80-4, which includes an associated lowermost outer veneer, first glue layer and intermediate veneers 54-14 and 54-24, is disposed on an assembly region 164C-4 and positioned at a fourth assembly stage at which a second glue layer 70-24 is applied onto intermediate veneers 54-14 and 54-24 as conveyor belt 163C-B moves assembly 80-4 under second glue applicator mechanism 165C-2. A fifth panel assembly 80-5 is disposed on an assembly region 164C-5 and positioned at a fifth assembly stage at which an uppermost veneer 55-25 has been deposited onto an associated lowermost outer veneer, a first glue layer, two intermediate veneers and a second glue layer (all of which being obscured by an uppermost veneer 55-25) by third robot mechanism 130C-3 and end-tool 140C-3. Third robot mechanism 130C-3 is positioned and configured to move uppermost veneer 55-25 from a third supply region (e.g., from stack 55S-2 provided on a third supply conveyor 161C-2) to designated work area 164C-5 during the fifth assembly stage. Image data generated by cameras mounted on end-tool 140C-3 is utilized by the work cell's control unit to coordinate operations of third robotic mechanism 130C-3 such that the selected side edge of uppermost veneer 55-25 is precisely aligned with the veneer side edges of underlying veneers, as indicated by panel side edge 83-51, and such that the veneer end edge of uppermost veneer 55-25 is precisely aligned with the selected veneer end edge of the underlying lowermost veneer, as indicated by panel end edge 82-51. A sixth (completed) panel assembly 80-6 is disposed in assembly region 164C-6 and includes all three veneer layers and two glue layers mentioned above. Completed assembly 80-6 is then moved to a post-assembly processing area (described above). The assembly-line configuration of work cell 100C can produce three-layer plywood panel assemblies at a faster rate than that achievable by work cell 100B (see FIG. 11A) but cannot be utilized to produce plywood panels having more than three layers without more significant modification (e.g., by way of lengthening conveyor-type assembly structure 163C and including additional robot mechanisms and glue applicator mechanisms, e.g., as described below with reference to FIGS. 16A to 16C).

FIGS. 13 and 14A to 14C show a partial plywood production work cell 100D according to another exemplary embodiment. Similar to work cell 100B (described above), work cell 100D utilizes a conveyor-type assembly structure 163D and multiple robot mechanisms 130D-1 to 130D-4 and two glue applicator mechanisms 165D-1 and 165D-2 to produce three-layer plywood panel assemblies in an automated assembly-line manner such that selected side edges of all three veneer layers are precisely aligned and selected end edges of the two outer full-size veneers are precisely aligned for reasons set forth above. Work cell 100D differs from previous embodiments in that two robot mechanisms 130D-2 and 130D-3 are utilized to place half-size intermediate veneers in an end-to-end arrangement that forms a continuous layer extending between edge-aligned pairs of uppermost and lowermost full-size veneers. That is, unlike previous embodiments in which a selected end edge of one of the two intermediate veneers is aligned with the selected end edge of the lowermost full-size veneer, work cell 100D is configured to arrange the intermediate veneers in a continuous end-to-end manner. As set forth below, although this arrangement requires additional processing (e.g., the flying saw cut depicted in FIG. 14C), the continuous intermediate layer approach utilized by work cell 140D may be advantageous in some applications.

FIGS. 13, 14A and 14B show a portion of continuous conveyor belt 163D-B that includes six sequentially aligned work areas (assembly regions) 164D-1 to 164D-6, which in this embodiment are respectively occupied by partially completed plywood panel assemblies 80-1 to 80-6. Conveyor-type assembly structure 163D is otherwise configured and operates in a manner similar to that described above with reference to conveyor-type assembly structure 163C (FIG. 12) to facilitate the simultaneous production of plywood panel assemblies 80-1 to 80-6. FIG. 14C depicts an additional portion of continuous conveyor belt 163D-B that includes two additional sequentially aligned work areas 164D-7 and 164D-8 respectively occupied by plywood panel assemblies 80-7 to 80-8, and an optional second conveyor-type assembly structure 163D-2 positioned and configured to move completed panel assemblies (e.g., panel assembly 80-9) to a post-assembly smoothing/processing station (not shown).

Referring to FIG. 13, robot mechanisms 130D-1 to 130D-4 are configured and controlled by a control unit (not shown) in a manner similar to that described above. Robot mechanisms 130D-1, 130D-2, 130D-3 and 130D-4 respectively include associated end-tool 140D-11, 140D-21, 140D-22 and 140D-12 that are respectively connected to distal end portions of multi-section arm portions 133D-1, 133D-2, 133D-3 and 133D-4 of corresponding six-axis robots 131D-1, 131D-2, 131D-3 and 131D-4. End-tools 140D-11 to 140D-22 differ from the end-tools used in previously described embodiments (e.g., end-tool 140A, described above). That is, end-tool 140A includes a full-size frame and multiple cameras positioned to facilitate securing and transferring either one full-size veneer or two half-size veneers. In contrast, end-tools 140D-11 and 140D-12 are configured in a way that may be restricted to the transfer of full-size veneers, and end-tools 140D-11 and 140D-12 are configured to transfer a single half-size veneer.

Specifically, as shown in FIG. 13A, end-tools 140D-11 and 140D-12 includes eight vacuum grippers arranged in two X-shaped groups 151D-X1 and 151D-X2 and are otherwise configured in a manner similar to previous embodiments, but utilize only three cameras 121D-11, 121D-12 and 122D-1 arranged to generate image data associated with a selected side edge and a selected end edge during the transfer of full-size veneers from associated supply stacks to conveyor-type assembly structure 163D. As indicated in FIG. 13B, end-tools 140D-21 and 140D-22 include four vacuum grippers arranged in a single X-shaped group 151D-X and mounted on a half-size frame 141D, and utilize three cameras 121D-1, 121D-2 and 122D-1 arranged to generate image data during the transfer of a single half-size veneer from an associated supply stack to conveyor-type assembly structure 163D. In other embodiments (not shown), work cell 100D may be modified to utilize end-tool 140A in place of one or more of end-tools 140D-11 to 140D-22.

The operation of work cell 100D will now be described with reference to FIGS. 13 and 14A-14C.

Referring to the upper portion of FIG. 13 and to the left side of FIG. 14A, (first) robot mechanism 130D-1 is positioned and configured to move lowermost full-size veneer 55-11 (by way of end-tool 140-11) from a first supply region (e.g., supply conveyor 161D-1, FIG. 13) into designated work area 164D-1 during a first assembly phase/stage, thereby forming partial assembly 80-1. Glue applicator mechanism 165D-1 is positioned and configured to apply a first glue layer 70-12 onto lowermost outer veneer 55-12 of plywood panel assembly 80-2, which is disposed in work area 164D-2, during a second assembly stage. Referring to the center of FIG. 13 and to the right side of FIG. 14A, robot mechanisms 130D-2 and 130D-3 are positioned and configured to utilize end-tools 140D-21 and 140D-22 to move intermediate veneers from associated supply regions (e.g., from veneer supply stack 54S-1 provided on supply conveyor 162D-1 and from veneer supply stack 54S-2 provided on supply conveyor 162D-2) to a work area 164D-3 during a third assembly stage. Robot mechanisms 130D-2 and 130D-3 are configured to sequentially place the intermediate veneers in and end-to-end configuration (i.e., such that end edge 54-1 2E1 of intermediate veneer 54-12 abuts/contacts a corresponding end edge of first adjacent intermediate veneer 54-11 and a second end edge 54-12 E2 of intermediate veneer 54-12 abuts a corresponding end edge of second adjacent intermediate veneer 54-13, whereby the intermediate veneers (e.g., veneers 54-11 to 54-14) form a continuous intermediate layer 54L.

Referring to FIG. 13 and to the left side of FIG. 14B, glue applicator mechanism 165D-2 is positioned and configured to apply a second glue layer (e.g., glue layer 70-2) onto the intermediate veneers forming continuous intermediate layer 54L during a fourth assembly stage. In the depicted embodiment, second glue layer 70-2 is deposited onto intermediate veneer 54-14 as conveyor belt 163D-B moves plywood panel assembly 80-4 under glue applicator mechanism 165D-2. Referring to the lower portion of FIG. 13 and to the right side of FIG. 14B, robot mechanism 130D-4 is positioned and configured to move an uppermost veneer 55-15 (using end-tool 140D-12) from a third supply region (e.g., stack 55S-2 provided on supply conveyor 161D-2) to designated work area 164D-5 during a fifth assembly stage. Image data generated by cameras mounted on end-tool 140D-22 is utilized by the work cell's control unit to coordinate operations of robotic mechanism 130D-4 such that the selected side edge of uppermost veneer 55-25 is precisely aligned with the veneer side edges of underlying veneers and such that the veneer end edge of uppermost veneer 55-25 is precisely aligned with the selected veneer end edge of the underlying lowermost veneer, as indicated in FIG. 14B by panel end edge 82-51.

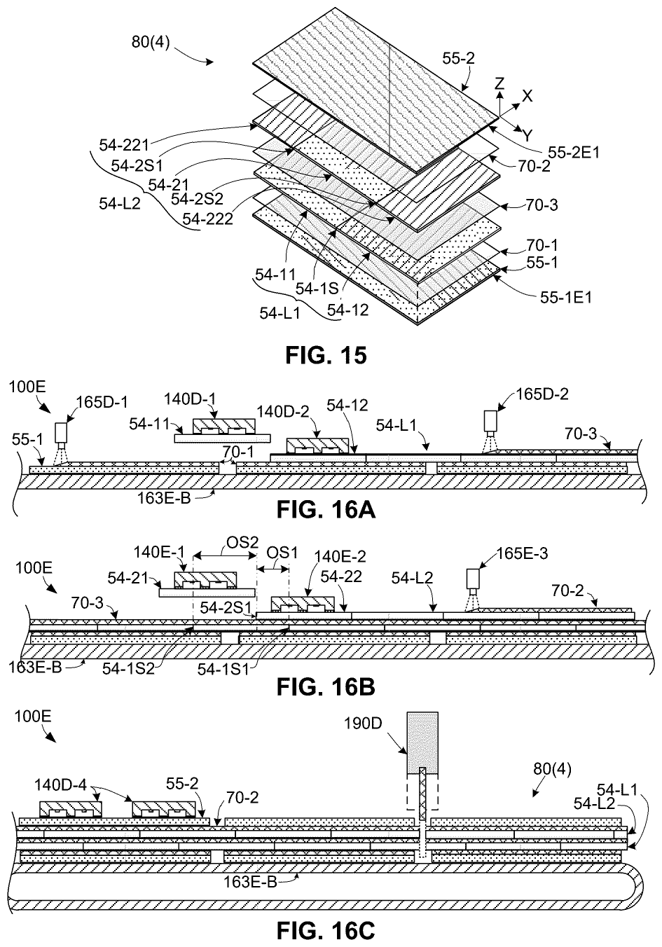

Work cell 100D further includes a suitable cutting/separating mechanism that is positioned, configured and controlled to cut portions of continuous intermediate layer 54L extending between adjacent pairs of plywood panel assemblies. Referring to the right side of FIG. 14B, adjacent plywood panel assemblies 80-5 and 80-6 are fixedly connected to each other by an intervening portion 54L-56 of continuous intermediate layer 54L. As indicated in FIG. 14C, work cell 100D includes a flying saw 190D that is positioned and controlled (e.g., as indicated by dashed-lines) to perform a flying saw cut FSC on each intervening portion of continuous intermediate layer 54L (e.g., to separate plywood panel assembly 80-8 from adjacent plywood panel assembly 80-7). In one embodiment, flying saw 190D is positioned and controlled such that each flying saw cut only passes through the intermediate veneer material forming layer 54L (i.e., the cutting blade of flying saw 190D does not contact lowermost veneer 55-18 and uppermost veneer 55-28 of plywood panel assembly 80-8 when performing flying saw cut FSC). Although the formation of continuous intermediate layer 54L requires additional post-assembly processing (e.g., separation of the plywood panel assemblies and possible additional smoothing of the intermediate layer along the aligned end edge), the continuous intermediate layer approach utilized by work cell 140D may be advantageous, for example, in the production of four-layer plywood panels as described below with reference to FIGS. 15 and 16A-16C.

FIG. 15 depicts a partial four-ply plywood panel assembly 80(4) according to an exemplary embodiment. Similar to the three-ply assemblies 80 (described above), four-ply plywood panel assembly 80(4) includes a lowermost (first outer) full-size veneer 55-1 and an uppermost (second outer) full-size veneer 55-2 that are oriented such that their grains extend in parallel with the Y-axis direction. Four-ply plywood panel assembly 80(4) differs from the three-ply assemblies described above in that it includes two intermediate veneer layers 54-L1 and 54-L2, where second intermediate layer 54-L2 is included to provide four-ply plywood panel assembly 80(4) with additional strength and rigidity. Note that the veneers forming both intermediate veneer layers 54-L1 and 54-L2 have grains that extend in the X-axis direction (i.e., perpendicular to the grains of full-size veneers 55-1 and 55-2. Note also that the veneers forming intermediate layers 54-L1 and 54-L2 are arranged in an offset configuration to prevent the vertical alignment of seams between adjacent veneers, which can create an undesirable weak point. In the depicted example, first intermediate veneer layer 54-L1 includes two half-size veneers 54-11 and 54-12 arranged such that abutting end edges form a first seam 54-1S that extends in the X-axis direction, and second intermediate veneer layer 54-L2 includes a single half-size veneer 54-21 and two quarter-size veneers 54-211 and 54-212, where a first end edge of half-size veneer 54-21 abuts with an end edge of quarter-size 54-221 to form a second seam 54-2S1 and the opposing second end edge of half-size veneer 54-21 abuts with an end edge of quarter-size 54-222 to form a third seam 54-2S2. With this arrangement, first seam 54-1S is offset in the Y-axis direction from (i.e., are not vertically aligned with) second seam 54-2S1 and third seam 54-2S2, thereby avoiding a potential weak point that can result when first seam 54-1S may be vertically aligned with either of second seam 54-2S1 and third seam 54-2S2. Four-ply plywood panel assembly 80(4) also differs from the three-ply assemblies described above in that it includes three glue (adhesive) layers 70-1, 70-2 and 70-3 (i.e., an additional “intermediate” glue layer 70-3 is included between intermediate veneer layers 54-L1 and 54-L2).

FIGS. 16A to 16C depict a partial plywood production work cell 100E configured to generate four-ply plywood panel assemblies according to an exemplary embodiment. For brevity and clarity, portions of plywood production work cell 100E that are configured and operate substantially as described above with reference to plywood production work cell 100D are indicated using the same reference numbers. For example, as indicated on the left side of FIG. 16A, after a lowermost full-sized veneer 55-1 is placed on a conveyor belt 163E-B by a first robot mechanism (not shown), a first glue applicator mechanism 165D-1 applies a first glue layer 70-1 in the manner described above with reference to FIGS. 13 and 14A. As indicated in the central portion of FIG. 16A, second and third robots (not shown) then utilize end-tools 140D-1 and 140D-2 to place half-size veneers 54-11 and 54-12 on lowermost full-size veneer 55-1 with first glue layer 70-1 sandwiched therebetween, thereby forming first intermediate layer 54-L1 that bridges across adjacent lowermost full-size veneers in the manner described above with reference to FIGS. 13 and 14A. Referring to the right side of FIG. 16A, a second glue applicator mechanism 165D-2 applies intermediate glue layer 70-3 onto first intermediate layer 54-L1 in the manner described above with reference to FIGS. 13 and 14A. As indicated on the left side of FIG. 16B, fourth and fifth robots (not shown) then utilize end-tools 140E-1 and 140E-2 to place half-size veneers 54-21 and 54-22 on first intermediate veneer layer 54-L1 with intermediate glue layer 70-3 sandwiched therebetween, thereby forming second intermediate layer 54-L2. Note that half-size veneers 54-21 and 54-22 are positioned such that intervening seam 54-S21 is located at a first offset distance OS1 from a first seam 54-1S1 of first intermediate veneer layer 54-L1, and by is located at a second offset distance OS2 from a second seam 54-1S2 of first intermediate veneer layer 54-L1. Referring to the right side of FIG. 16B, a third glue applicator mechanism 165E-3 applies an upper glue layer 70-2 onto second intermediate layer 54-L2 in a manner similar to that described above. Referring to the left side of FIG. 16C, a sixth robot (not shown) then utilizes end-tool 140D-4 to place full-size veneer 55-2 on second intermediate veneer layer 54-L2 with upper glue layer 70-2 sandwiched therebetween, and then flying saw 190D cuts through portions of the first and second intermediate layers to form separate four-ply panel assemblies 80(4) in a manner similar to that described above with reference to FIG. 14C.

The exemplary embodiments described with reference to FIGS. 15 and 16A-16C illustrate that, in order to achieve the required seam offset between intermediate veneer layers 54-L1 and 54-L2, at least one of first intermediate veneer layer 54-L1 and second intermediate veneer layer 54-L2 necessarily includes more than two veneer pieces. That is, referring to FIG. 15, when first intermediate layer 54-L1 is implemented using two half-size veneers, second intermediate layer 54-L2 must include more than two veneer pieces to prevent undesirable seam alignment. With this requirement, the precise alignment of the selected end edge of all four veneer layers may be impractical, whereby the end-to-end arrangement of the intermediate veneer layers described with reference to FIGS. 13 through 16C may be more efficient and produce less waste. That is, although the panel assemblies must be separated, the additional flying saw cut only passes through the intermediate veneer layers, and subsequent processing to planarize the selected end edge mainly involves removing excess intermediate veneer material (i.e., little or no material must be removed from the precisely aligned select end edges 55-1E1 and 55-2E1 of lowermost full-size veneer 55-1 and uppermost full-size veneer 55-2, respectively.

In addition to the post-assembly processing described above, in some embodiments each plywood panel assembly may be further processed to achieve the targeted final width/length dimensions. For example, in some embodiments in which veneers are provided with slightly meandering edges (i.e., the side and end edges deviate from the desired straight-line configuration), an additional trim saw cut may be employed after the hot press process to remove thin (e.g., approximately one-half inch wide) strips of material from the selected side and end edges by before substantially wider cuts are performed along the opposing (non-aligned) edges to achieve the targeted final length/width dimensions.

Although the present invention has been described with respect to certain specific embodiments, it will be clear to those skilled in the art that the inventive features of the present invention are applicable to other embodiments as well, all of which are intended to fall within the scope of the present invention. For example, although described with specific reference to the production of three-layer 8′×4′ plywood panels, the methods described herein may be utilized to produce plywood panels having more layers (e.g., five-layers) and different peripheral sizes without deviating from the described inventive process. Moreover, although the invention has been described with specific reference to six-axis robots, other robotic systems (e.g., four-axis robots or five-axis robots) may also be utilized to implement this invention.

1. A method for producing plywood panels having a specified length and a specified width, each plywood panel including a plurality of veneers stacked such that at least two intermediate veneers are sandwiched between a first outer veneer and a second outer veneer, the method comprising:
placing the first outer veneer into an assembly region, the first outer veneer having a first selected side edge, a first opposing side edge, a first selected end edge and a first opposing end edge;
controlling at least one robot mechanism to place a plurality of intermediate veneers on the first outer veneer, wherein said controlling includes utilizing sensor data to position the intermediate veneers relative to the first outer veneer such that a second selected side edge of each said intermediate veneer is vertically aligned with the first selected side edge of the first outer veneer;
controlling said at least one robot mechanism to place the second outer veneer on the intermediate veneers such that a third selected side edge of the second outer veneer is vertically aligned with the first selected side edge of the first outer veneer and such that a second selected end edge of the second outer veneer is vertically aligned with the first selected end edge of the first outer veneer, whereby the first and second outer veneers and the intermediate veneers collectively form an assembly having an aligned panel side edge formed by the vertically aligned first, second and third selected side edges, an opposing panel side edge formed by the opposing side edges of the first outer, intermediate and second outer veneers, an aligned panel end edge formed by the vertically aligned first and second selected end edges, and an opposing panel end edge formed by the opposing end edges of the first outer veneer and the second outer veneer; and
removing first portions of the first outer veneer, at least one intermediate veneer and the second outer veneers from the opposing panel side edge until a width of the assembly between the aligned panel side edge and the opposing panel side edge is equal to the specified width, and removing second portions of the first outer veneer, at least one intermediate veneer and the second outer veneers from the opposing panel end edge until a length of the assembly between the aligned panel end edge and the opposing panel end edge is equal to the specified length.

2. The method of claim 1, wherein controlling said at least one robot mechanism to place the plurality of intermediate veneers on the first outer veneer further comprises utilizing the sensor data to position a first intermediate veneer of the plurality of intermediate veneers relative to the first outer veneer such that a selected end edge of said first intermediate veneer is vertically aligned with the first selected end edge of the first outer veneer.

3. The method of claim 2, further comprising controlling said at least one robot mechanism to move the first outer veneer from a first supply region to a designated assembly region during a first assembly phase,
wherein controlling said at least one robot mechanism to place the intermediate veneers comprises controlling said at least one robot mechanism to move two intermediate veneers from a second supply region to the designated assembly region during a second assembly phase occurring after the first assembly phase, and
wherein controlling said at least one robot mechanism to place the second outer veneer comprises controlling said at least one robot mechanism to move the second outer veneer from one of (a) the first supply region and (b) a third supply region to the designated assembly region during a third assembly phase.

4. The method of claim 3,
wherein controlling said at least one robot mechanism to place the first outer veneer comprises controlling a first robot mechanism to move the first outer veneer from the first supply region to the designated assembly region during the first assembly phase, and
wherein controlling said at least one robot mechanism to place the two intermediate veneers comprises controlling a second robot mechanism to move the two intermediate veneers from the second supply region to the designated assembly region during the second assembly phase.

5. The method of claim 3, wherein controlling said at least one robot mechanism to move the second outer veneer comprises utilizing a robotic end-tool including one or more vacuum grippers to secure and lift the second outer veneer from a veneer supply stack disposed in said one of said first supply region and said third supply region and to place the second outer veneer onto the two intermediate veneers, wherein said one or more vacuum grippers are configured to maintain said second outer veneer in a substantially horizontal orientation during said movement from the veneer supply stack to said placement on the two intermediate veneers.

6. The method of claim 3,
wherein utilizing said sensor data comprises utilizing a camera fixedly mounted onto the robotic end-tool to generate first image data including a location of the first selected side edge of the first outer veneer, and
wherein controlling said at least one robot mechanism to place the second veneer on the two intermediate veneers comprises utilizing said first image data to vertically align a second selected side edge of the second outer veneer with the first selected side edge of the first outer veneer.

7. The method of claim 3, further comprising:
utilizing a first supply conveyor to move the first outer veneer and the second outer veneer into the first supply region, and
utilizing a second supply conveyor to move the two intermediate veneers into the second supply region.

8. The method of claim 3,
wherein controlling said at least one robot mechanism to move the first outer veneer comprises placing the first outer veneer in the designated assembly region such that a grain of the first outer veneer is aligned in a first direction when the first outer veneer is placed in the designated assembly region,
wherein controlling said at least one robot mechanism to place the two intermediate veneers comprises aligning grains of both of the two intermediate veneers in a second direction that is perpendicular to the first direction when the two intermediate veneers are placed on the first outer veneer, and
wherein controlling said at least one robot mechanism to place the second outer veneer comprises aligning a grain of the second outer veneer in the first direction when the second outer veneer is placed on the two intermediate veneers.

9. The method of claim 3, wherein controlling said at least one robot mechanism to move the two intermediate veneers from the first supply region comprises:
controlling said at least one robot mechanism to remove a first intermediate veneer from a veneer supply stack using a first portion of an end-tool,
controlling said at least one robot mechanism to remove a second intermediate veneer from the veneer supply stack using a second portion of the end-tool such that said selected side edges of the first and second veneers are aligned, and
controlling said at least one robot mechanism to simultaneously move the first and second intermediate veneers to the designated assembly region.

10. The method of claim 1, further comprising:
applying a first glue layer onto the first outer veneer before controlling said at least one robot mechanism to place the two intermediate veneers on the first outer veneer; and
applying a second glue layer onto the two intermediate veneers before controlling said at least one robot mechanism to place the second outer veneer on the two intermediate veneers.

11. A robotic work cell for producing an assembly utilized in the production of a plywood panel, said assembly comprising a plurality of veneers including at least two intermediate veneers sandwiched between a first outer veneer and a second outer veneer, each said veneer having an associated peripheral edge including a selected side edge and an opposing side edge and a selected end edge and an opposing end edge, the robotic work cell comprising:
a sensor system configured to determine a location of the selected side edge and a location of the selected end edge of at least one of the plurality of veneers, and to generate sensor data specifying each determined location;
at least one robot mechanism configured to generate said assembly by moving the first outer veneer into an assembly region during a first assembly phase, then stacking the intermediate veneers onto the first outer veneer during a second assembly phase, and then stacking the second outer veneer onto the intermediate veneers during a third assembly phase; and
a control unit configured to control the robot mechanism in accordance with the sensor data such that:
when the intermediate veneers are placed on the first outer veneer, the selected side edges of each intermediate veneer is vertically aligned with the selected side edge of the first outer veneer, and
when the second outer veneer is placed on the intermediate veneers, the selected side edge of the second outer veneer is vertically aligned with the selected side edge of the first outer veneer, and the selected end edge of the second outer veneer is vertically aligned with the selected end edge of the first outer veneer.

12. The robotic work cell of claim 11, wherein said at least one robot mechanism comprises:
an articulated robot including a multi-section arm portion, a distal end portion disposed at a distal end of said multi-section arm portion; and
an end-tool attached to said distal end portion, wherein the end-tool is configured to secure at least one of the first outer veneer to the distal end portion during the first assembly phase, the two intermediate veneers to the distal end portion during the second assembly phase, and the second outer veneer to the distal end portion during the third assembly phase.

13. The robotic work cell of claim 12, wherein the end-tool comprises:
a frame including:
a spar,
a central hub fixture fixedly connected to a central region of the spar and configured for fixed connection to the distal end portion such that the spar is maintained in a first horizontal direction, and
a plurality of ribs fixedly connected to the elongated spar and extending in a second horizontal direction that is perpendicular to the first horizontal direction;
a plurality of vacuum grippers, each said vacuum gripper having a housing connected to an associated rib of said plurality of ribs, each elongated housing including one or more vacuum cavities respectively having a downward-facing opening, wherein the plurality of vacuum grippers are disposed in a plane below the spar; and
a plurality of cameras fixedly connected to the frame, each camera being vertically oriented and positioned such that, when a veneer is secured by the plurality of vacuum grippers, said each camera captures image data corresponding to a section of the peripheral edge of the secured veneer.

14. The robotic work cell of claim 13, wherein the sensor system comprises a vision system including:
a first camera mounted on the frame and respectively positioned to generate first image data corresponding to the selected side edge of said secured veneer; and
a second camera mounted on the frame and respectively positioned to generate second image data corresponding to the selected end edge of said secured veneer,
wherein the control unit is configured to control the robot mechanism in accordance with the first image data and the second image data.

15. The robotic work cell of claim 12,
wherein the robotic end-tool includes a frame and a plurality of vacuum grippers connected to the frame and arranged in first and second X-shaped groups, and
wherein the robotic work cell further comprises a vacuum system including at least one vacuum generator operably configured to transmit low pressure to each of the plurality of vacuum grippers during the first, second and third assembly phases.

16. The robotic work cell of claim 14, further comprising an assembly structure including the assembly region and a glue applicator mechanism configured to apply a first glue layer onto an upward facing surface of the first outer veneer after the first outer veneer is placed in the assembly region, and to apply a second glue layer onto an upward facing surface of the two intermediate veneers after the two intermediate veneers are placed in the assembly region.

17. The robotic work cell of claim 11, wherein said at least one robot mechanism comprises:
a first robot mechanism including a first articulated robot having a first multi-section arm portion and a first end-tool attached to a distal end of said first multi-section arm portion, the first robot mechanism being configured to move the first outer veneer from a first supply region to the assembly region during the first assembly phase; and
a second robot mechanism including a second articulated robot having a second multi-section arm portion and a second end-tool attached to a distal end of said second multi-section arm portion, the second robot mechanism being configured to move at least one of said plurality of intermediate veneers from a second supply region to the assembly region during the second assembly phase.

18. A robotic end-tool configured for use by an articulated robot to perform an automated veneer stacking operation during which a plurality of veneers are moved from one or more supply regions and stacked in an assembly region, each said veneer having an associated peripheral edge including a selected side edge and an opposing side edge and a selected end edge and an opposing end edge, wherein the robot includes an arm portion and an end-shaft connected to a distal end of the arm portion such that the end-shaft is maintained in a vertical direction, the robotic end-tool comprising:
a frame including:
a spar,
a central hub fixture fixedly connected to a central region of the spar and configured for fixed connection to the end-shaft such that the spar is maintained in a first horizontal direction, and
a plurality of ribs fixedly connected to the spar and extending in a second horizontal direction that is perpendicular to the first horizontal direction;
a plurality of vacuum grippers, each said vacuum gripper having a housing connected to an associated rib of said plurality of ribs, each housing including one or more vacuum cavities respectively having a downward-facing opening, wherein the plurality of vacuum grippers are disposed in a plane below the spar; and
a plurality of cameras fixedly connected to the frame, each camera being vertically oriented and positioned such that, when a veneer is secured by the plurality of vacuum grippers, said each camera captures image data corresponding to a section of the peripheral edge of the secured veneer.
